(19) United States
(12) Patent Application Publication
(10) Pub. No.: US 2020/0090283 A1
(43) Pub. Date: Mar. 19, 2020

(54) SYSTEM AND METHOD OF ACCOUNTING/TAX PREPARATION REFERRALS

(71) Applicant: John I. Harrison, Tallahassee, FL (US)

(72) Inventor: John I. Harrison, Tallahassee, FL (US)

(21) Appl. No.: 16/139,158

(22) Filed: Sep. 24, 2018

Related U.S. Application Data
(60) Provisional application No. 62/732,530, filed on Sep. 17, 2018.

(51) Int. Cl. G06Q 40/00; G06Q 10/10

(52) U.S. Cl. CPC G06Q 40/123; G06Q 10/103

(57) ABSTRACT

A System and Method for Accounting/Tax Preparation Referrals assists CPAs, Individuals and Centers of Influence (trade associations, employers, social groups) in obtaining compensation using a computer networked referral system. CPAs joining the system are tagged as SASBA CPAs, Individuals are tagged as RB Members if they do not have businesses and RB Owners if they do. A final COI tag is used for those in the first three groups. IRS regulations dictate that generally any activity with the expectation of profit qualifies as a business. Periodic transmission of referral links via emails, instant messages and similar modalities with the expectation of receiving a profit from SASBA for the referral can qualify one as a business. Because of this, individuals without a business who are referred to SASBA can create their own business and take advantage of existing tax strategies, compensation for their own referrals to SASBA and other advantages.

### FIELD OF THE INVENTION

The present invention relates generally to accounting/income tax preparation, and more particularly relates to a method and system for bringing together accountants, business owners, and individuals in order to facilitate various business practices.

### BACKGROUND OF THE INVENTION

### United States Patent Documents

U.S. Pat. No. 7,337,133 to Bezos et al. teaches an Internet-based customer referral system which enables individuals and other business entities (“associates”) to refer customers to a merchant's web site in return for compensation, such as commissions on resulting sales. Entities initially register with the merchant web site as associates, and are provided with instructions for creating links to the merchant web site. An associate may, for example, set up an associate web site (or other information dissemination system) with reviews, recommendations, and/or editorials of specific products in the merchant's online catalog, together with links to associated pages in the catalog. When a user follows such a link and then makes a purchase (as tracked by the merchant web site), the system preferably awards a commission to the associate. The system also preferably generates feedback reports that provide each associate with data regarding the effectiveness of each link provided by that associate.

U.S. Pat. No. 7,953,644 to Tracey teaches a networking system for referrals that connects businesses (vendor) with their customers (member) and potential customers (prospective member) across a network. Once a vendor has joined the network, the vendor may invite other members to join. A member can then refer a prospective member to the vendor. If the prospective member purchases goods or services from the vendor, the vendor will confirm the sale by paying a referral fee to the network. The network distributes said referral fee according to the connection relationship of the members of the network.

U.S. Pat. No. 8,271,326 to Brunet et al. teaches systems and methods disclosed for tracking, reporting and performing processing activities and transactions in association with referral data and related information for a variety of product and service offerings. Further, Brunet teaches a Referral Processing and Tracking System. In particular, the service provider 204 of FIG. 2, item 204 is optionally a Tax Service (Column 3, line 58).

U.S. Pat. No. 8,494,923 to Bezos et al. teaches an Internet-based customer referral system which enables individuals and other business entities (“associates”) to market products sold on a merchant web site in return for commissions. Following registration, the associate sets up a web site (or other information dissemination system) to distribute hypertextual catalog documents that include marketing information (product reviews, recommendations, etc.) about selected products of the merchant. In association with each such product, the catalog document includes a hypertextual “referral link” that allows a user/customer to access the merchant web site and purchase the product. When a customer selects a referral link, the customer's computer transmits unique IDs of the selected product and of the associate to the merchant's site, allowing the merchant to identify the product and the referring associate. If the customer subsequently purchases a product from the merchant's site, a commission is automatically credited to an account of the referring associate.

U.S. Pat. No. 8,515,888 to Ventilla et al. teaches methods, systems, and apparatus, including computer programs encoded on a computer storage medium, for a social search engine. In one aspect, a method includes receiving an answer to a question from an answerer; identifying an entity in the answer, in which the entity refers to a product, a service, a company, or a merchant; obtaining permission from the answerer to provide an interactive link for the entity in the answer to a resource from which the entity can be obtained; receiving a user submitted query and determining that the query is related to the entity; and responsive to determining, providing the answer, including the link to the resource, as part of search results that are responsive to the query.

### Internal Revenue Service Regulations

The Internal Revenue Service (IRS) is the United States Federal Agency charged to collect income taxes from the general population and businesses within the United States of America. Current IRS regulations state generally that an activity qualifies as a business if it has a reasonable expectation of earning a profit. Thus, it follows that if one wanted to get the tax advantages of running a business in the United States of America, it would be necessary to conduct an activity that has a reasonable expectation of profit as required by the IRS rules.

### Overview

A Certified Public Accountant (CPA) that desires to start his or her practice has many hopes in the endeavor. However, most are not ready for the challenges of generating new clients and are blindsided by the need to market their practice. Typically, they setup the basics of the business such as renting an office, purchasing furniture, equipment, and so forth. Most have taken a loan to finance the startup costs and then reality hits that there are no clients and therefore no cash flow; but, of course, the debt is in place.

As stated previously, most start their business without having any notion of the need to market the business and only have a general hope for new business to arrive. It is because of this they do not understand the need for a good marketing strategy to create referrals and new clientele. The inventor learned that not only himself, but the vast majority of CPAs, are not fantastic salespeople nor do they have great contacts or important clients that could help develop their business. The inventor learned this not through sales acumen, not through cold calling on new clients and not even by marketing in various personal and business meetings.

On the contrary, the solution to a comprehensive marketing strategy dawned on the inventor through a lucky break. In a meeting with a friend with an insurance agency, the inventor was asked if he would be interested in preparing a series of presentations about taxes to a group of about two dozen agents desiring to pass the tax section of the CLU Examination.

As a favor to his friend the inventor proceeded to teach the agents about various aspects of the tax law. This led to friendships with most, if not all, of the two dozen agents. Somewhat more than half of these never provided any referrals for future business; however, about five or six sent him new referrals on occasion. But what was most awesome and enlightening, was that a few seem to wake up almost each and every day with an objective of finding him a new client.

Thus, there was born an excellent marketing strategy in that persons who are not employees would act as personal referral agents and/or sources of new business. Of course, the question arose as to how to implement such a strategy using technology to resolve the marketing problem. It really was a difficult task to duplicate the direct communication with various agents and the personal interaction in a classroom.

Thus, a technological solution to this problem needed to be found. The first marketing strategy of the System and Method of Accounting/Tax Preparation Referrals is to find some solution that could replicate the success of the personal referral system using technology that the inventor had found in the classroom. Additionally, there was a need to create a ‘hunter’ strategy whereby unpaid friends, clients and associates of the businessperson would freely refer new clients to the business. Most particularly, there was a need to show how to turn several dozen or more existing clients into ‘hunters’ for new business without requiring much work or effort on their part. The essential question was how can we covert our present group of clients into being our marketing staff without incurring any out of pocket costs for the referrals? The instant application answers all of these questions and provides a unique technological solution to this problem.

A second marketing strategy of the System and Method of Accounting/Tax Preparation Referrals is known as the Unique Value Proposition (UVP) practice method. In other words, what unique value could a CPA provide a new client that other CPAs could not offer? In the early 1990s the inventor wanted to provide small businesses with write-up services at affordable rates. However, at these rates it appeared that the accounting practice itself might not be viable. His intention was to provide small businesses with clear, concise understandable reports that were better than the competition at a large discount from other accounting practices. As a result, in a short time period (6 months) he was servicing fifty-nine monthly processing clients which is an unheard of growth in the accounting field. Additionally, after proving that this could work he began to market the UVP method across the country through a franchise called CFOToday.

CFOToday was very successful and at one time, it was the second largest accounting franchise in the US; however, various challenges immediately presented themselves. In particular, programs like QuickBooks, and the potential limitation on the franchisee prospects to allow for enormous growth all combined to stall the prospects of the UVP franchise CFOToday. However, the products and services that the franchise offered to the franchisee were not the problem. In fact, the main problem with the franchise model itself was that it was structured upon royalties, franchise fees, name change, restrictive contracts and so forth. Additionally, no accounting franchise has been able to create a franchise conversion model whereby existing accounting practices are converted into a franchise model. Thus, there was a need to offer a technological solution whereby the UVP method could be propagated into creating new business without the franchise model. This System and Method of Accounting/Tax Preparation Referrals process will provide SASBA CPAs with a UVP which provides their non-business owners a substantial tax planning opportunity that other CPAs will not be able to provide.

### SUMMARY OF THE INVENTION

The present invention overcomes the deficiencies of the known art and the problems that remain unsolved by providing a System and Method for Accounting/Tax Preparation Referrals.

A method of networked computer referrals comprises steps of:

a computer server having control software loaded thereon transmitting an invitation across a computer network to an accountant using the control software for joining of a referral group;

receiving a positive reply from the accountant at the computer server;

the control software processing of the positive reply in the computer server and storing the positive reply within a referral space in the computer server;

the computer server generating a signature to the positive reply using control software loaded into the computer server and storing the signature to the positive reply within a referral space associated with the positive reply previously stored therein.

In another aspect, wherein the signature further comprises a SASBA CPA tag.
In another aspect, further comprising the step of:

transmitting a web application form for an entry of demographic information and acceptance of terms.

In another aspect, further comprising the step of:

tagging a user of the method networked computer referrals as a unique type of entity using a tag referring to a type of membership of the referral group.

In another aspect, further comprises a tag from a group of tags of: a COI Member—center of influence tag, a RB Member—paying referral business individual tag, and a RB Owner—non paying referral business owner.
In another aspect, further comprising the step of:

the control software on the computer server transmitting a request to an individual without a business to join as a referral business member.

In another aspect, further comprising:

receiving an acceptance by an individual without a business at the computer server to join the referral plan.

In another aspect, further comprising the step of:

the computer server control software generating a tax satisfaction tag for the individual without a business.

In another aspect, wherein the tax satisfaction tag for the individual without a business further comprises: a referral business member tag.
In another aspect, further comprising the step of:

the control software storing the tax satisfaction tag for the individual without a business on the computer server in association with demographic information relating to the individual without a business.

In another aspect, further comprising the step of:

the control software on the computer server transmitting a request to an individual with a business to join as a referral business member.

In another aspect, further comprising:

receiving an acceptance by an individual with a business at the computer server to join the referral plan.

In another aspect, further comprising the step of:

the computer server control software generating a Referral Business owner tag for the individual with a business.

In another aspect, further comprising the step of:

the control software storing the Referral Business owner tag for the individual with a business on the computer server in association with demographic information relating to the referral business owner.

An operating networked computer system comprising:

an electronic computer network having a networked computer server electronically associated with the electronic computer network such that the networked computer server has storage space therein;

wherein the storage space of the networked computer server has a software application space and a referral space; such that the software application space has a software application module stored therein; and

wherein the referral space has a business activity referral datum stored therein thereby providing evidence to an Internal Revenue Service that an activity complies with Federal regulations for starting a business.

In another aspect, further comprising:

the referral datum is a Referral Business Member Signature.

In another aspect, further comprising:

a secondary referral datum.

In another aspect, wherein the secondary referral datum comprises a Center of Influence signature.

A method of networked computer referrals comprising the steps of:

a referral server in communicative association with a computer network transmitting a request to a potential associate across the computer network using control software stored on the referral server;

receiving an acceptance reply from the potential associate across the computer network at the referral server using the control software;

entering a referral signature datum into a referral signature table on the referral server using the control software on the referral server wherein the referral signature datum is from a set of referral signature data comprising: a CPA tag, a Referral Business Owner tag, A RB Member tag, IRS compliance tag.

In another aspect, wherein the referral signature datum further comprises a Center of Influence tag.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1A presents a system level overview of the various technological components used in order to practice the System and Method of Accounting/Tax Preparation Referrals in an embodiment disclosed herein.

FIG. 1B presents a view of various components utilized in the System and Method of Accounting/Tax Preparation Referrals in an embodiment disclosed herein.

FIG. 1C presents a view of a Referral Space Table in the System and Method of Accounting/Tax Preparation Referrals in an embodiment disclosed herein.

FIG. 2A presents a High Level Process Flow Diagram of a System and Method of Accounting/Tax Preparation Referrals in an embodiment disclosed for the introductory process and for the membership of a tagged SASBA CPA.

FIG. 2B presents a High Level Process Flow Diagram of a System and Method of Accounting/Tax Preparation Referrals in an embodiment disclosed herein for the membership of someone without a business who wants to become a tagged Referral Business RB Member.

FIG. 2C presents a High Level Process Flow Diagram of a System and Method of Accounting/Tax Preparation Referrals in an embodiment disclosed herein for the membership of someone with an existing business who wants to become a tagged Referral Business Owner.

FIG. 2D presents a High Level Process Flow Diagram of a System and Method of Accounting/Tax Preparation Referrals in an embodiment disclosed herein for acceptance of membership as a tagged Center of Influence COI.

FIG. 2E presents a set of highlights of the System and Method of Accounting/Tax Preparation Referrals covering various points of the High Level Process Flow Diagram of a System and Method of Accounting/Tax Preparation Referrals in an embodiment disclosed herein.

FIG. 2F presents a diagram of various other benefits for Referral Business Owners and Referral Business Members in an embodiment of the System and Method of Accounting/Tax Preparation Referrals as disclosed herein.

FIG. 2G presents a generalized initial process overview of the SASBA System and Method of Accounting/Tax Preparation Referrals in an embodiment disclosed herein.

FIG. 2H presents a diagram describing the system and programming of InfusionSoft™ software or in tailor made software for the purpose of appropriately paying a referral partner the appropriate commission amount in an embodiment disclosed herein. This so that the proper amount can be credited to the aforementioned who have received their personalized tracking link PTL in an embodiment disclosed herein.

FIG. 2I presents a diagram as to what is a personalized tracking link is including a short email that is sent to each person having username, password and various share links in an embodiment disclosed herein.

FIG. 2J presents a diagram showing a login center of influence web form which gathers information including demographic and financial information for centers of influence in an embodiment disclosed herein.

FIG. 3A presents an alternative embodiment describing unique steps 201 of FIG. 2A in a view of 5-Step to Join Flow Module Diagram for sending the 5-Step Link to CPA's disclosed in a System and Method of Accounting/Tax Preparation Referrals in an embodiment disclosed herein. Here the control software 106 alone or in combination with account management software 111 transmits 301 an email to CPA's with a 5-Step Link of Social media Contacts inviting them to join SASBA. This email contains a link to a landing page 302 such as sasba.org/5-step-join. If the contact does not join, then the system is designed to sends the first of seven messages to this contact using a counter system such as found in FIG. 5 with a preset counter set to seven or any predetermined number of attempts to get the CPA to join. Finally, tabulated responses from users are presented 304 using control software 106 or InfusionSoft Analytics to SASBA personnel to find unique marketing efforts.

FIG. 3B presents an InfusionSoft screen analytics screenshot showing various types of responses to the links that have been sent to other in an embodiment disclosed herein. The above analytics are used to refine the email marketing campaign. SASBA uses such analytics results in the total delivered, number of emails opened, links clicked, links unopened, opt-ins, opt-outs, bounces, complaints and so forth.

FIG. 4A presents a flow diagram of the process by which a user joins SASBA thereby becoming a SASBA CPA in an embodiment disclosed herein.

FIG. 4B presents a view of the CPA sign up web form diagram disclosed in a System and Method of Accounting Referrals in an embodiment disclosed herein.

FIG. 4C presents a view of the Terms and Conditions Addendum which is part of the SASBA CPA agreement in an embodiment disclosed herein.

FIG. 4D presents a view of the InfusionSoft contact record screen in an embodiment disclosed herein.

FIG. 4E presents a view of a portion of the SASBA CPA operation manual table of contents including various topics related to the perfect referral business in an embodiment disclosed herein.

FIG. 5 presents a followup process in the signing up of SASBA CPAs in an embodiment disclosed herein.

FIG. 6A presents a flowchart describing the transmission of the personalized tracking link PTL such that the response where various objections, problems and a SASBA postscript are explained in an embodiment disclosed herein.

FIG. 6B presents a description of the Personalized Tracking Link that Referral Business Members use to have a reasonable expectation of profit; these PTLs are typically generated specifically for each user in an embodiment disclosed herein a typical link is https://sg228.isrefercom/go/refer/jharrison. This also shows how there is little work involved, no direct selling involved and no up-front costs. The page also shows how there is a reasonable expectation of profit matching IRS guidelines.

FIG. 7 presents an alternative software process (of steps 208B to 211 in FIG. 2B) by which an individual having decided to join SASBA is accepted therein, is tagged as RB member and is sent corresponding initial information in an alternative embodiment.

FIG. 8A presents an alternative or modified software process by which an individual business owner or individual non business owner or SASBA CPA having decided to join SASBA becomes a COI in an embodiment disclosed herein.

FIG. 8B presents a web form whereby the user has actuated a link to sign up as a Referral Business Member or navigated to the SASBA site independently; in so doing he or she is attempting to join and is presented by control software 106 or InfusionSoft™ with a sign up form in an embodiment herein disclosed.

FIG. 8C presents a popup or linked page whereby various terms and conditions of the System and Method of Accounting Referrals in an embodiment herein disclosed. This web form is linked from the signup web form of FIG. 8B for example, or presented as a popup directly from a link thereon or as a popup before signup.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In order to accomplish the technological solution to the problems discussed in the background of the invention, the inventor created Society of American Small Business Accountants (SASBA). It is clear to SASBA that the major unresolved business problem that faces most new and existing accounting practices is that they simply do not have an existing marketing strategy nor an effective one. As mentioned previously, any solution of this problem begins with a unique value proposition (UVP). Thus, it is an intention of SASBA to solve this problem and to overcome others as described herein.

In order to accomplish this goal, the inventor has kept the best part of the franchise business such as support, training, systems and so forth whilst eliminating the upfront and ongoing costs, name changes, long term contracts and so forth. Additionally, he is leveraging the prowess of the technological revolution in order to accomplish the aforementioned. In so doing, the internet and its social media phenomenon (such as Facebook™, LinkedIn™, as well as others) provided inspiration to SASBA in that core services are offered free of charge whilst a revenue stream is created from the premium products that are offered. These include such offerings as practice development instruction, record keeping outsourcing and extensive online training.

In light of the aforementioned, SASBA will attract CPAs and tax preparers with an existing client base who can then implement (with virtually no upfront costs) the products, services and systems developed by SASBA in a unique technological solution using social media, internet and other communication architectures present today.

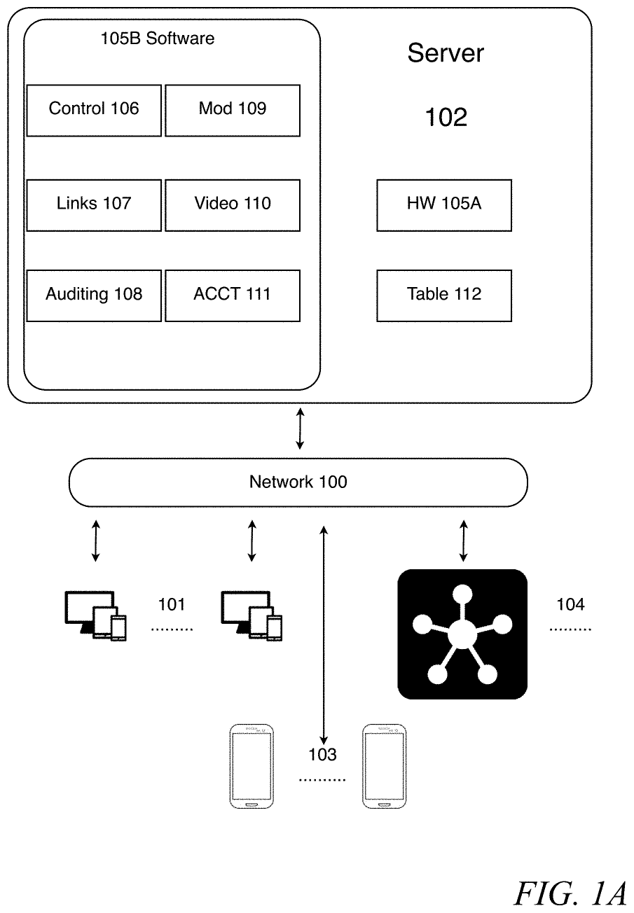

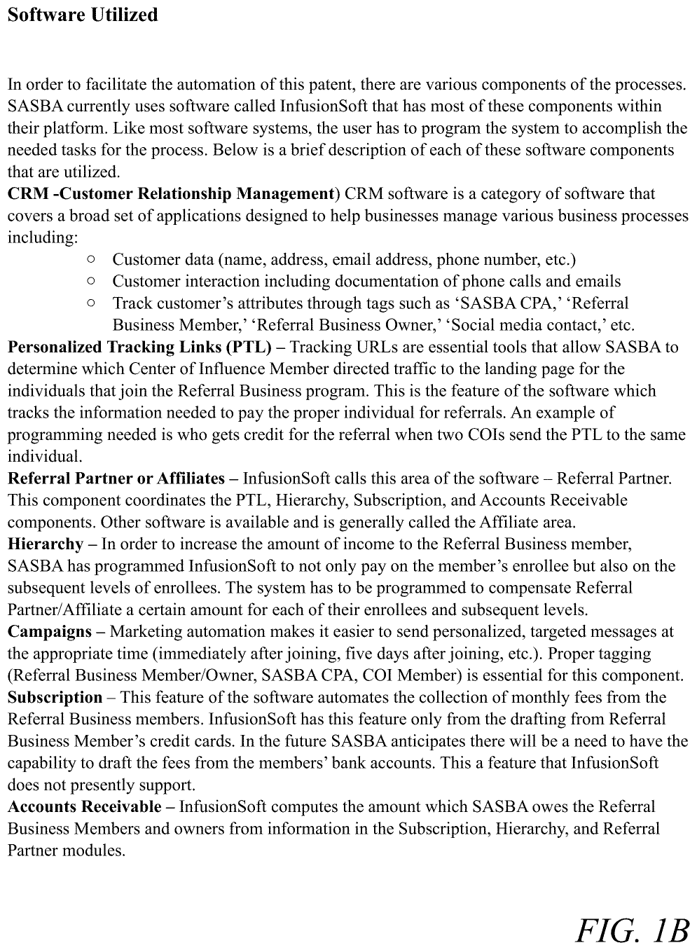

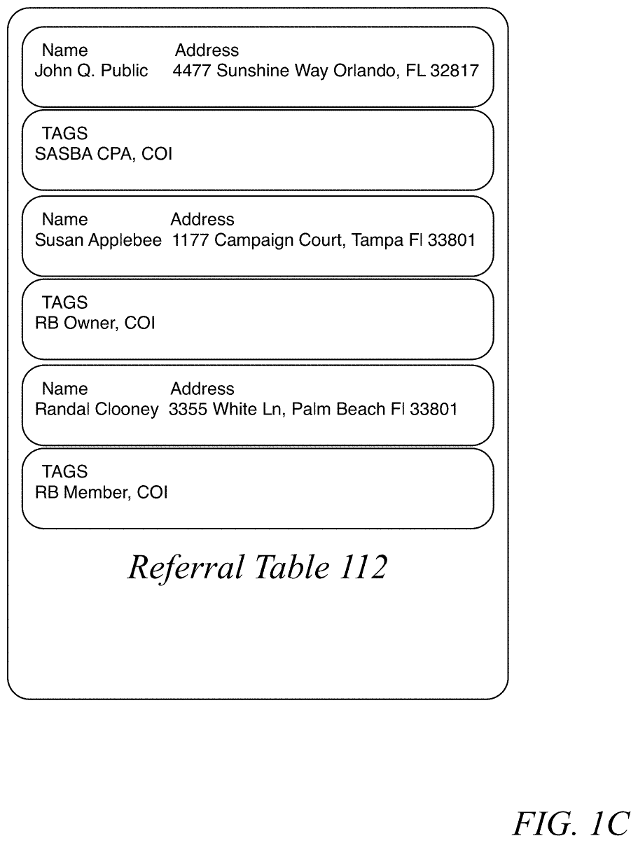

FIG. 1A presents a system level overview of the various technological components used in order to practice the System and Method of Accounting/Tax Preparation Referrals in an embodiment disclosed herein. FIG. 1A shows several advantageous features of the present invention, but as is to be described, the novelties discussed herein can be provided in several shapes, sizes, combinations of features and components and varying numbers and functions of the components. An example of a networked data processing system within which the concepts described herein can be practiced is shown including: a network 100, various standalone computers 101, a server system 102, mobile phones 103, auxiliary networks 104 and so forth. The server system 102 itself comprises one or more servers housing various applications found in software 105B, operating in conjunction with hardware 105A; the server system 102 can be co-located or dispersed to other sites as necessary to provide distributed functionality, control and communication in the event various system services or software are outsourced or to provide bandwidth load balancing across the network 100.

The server system 102 can be thought of as a single standalone computer operating as a server having its own application space and database storage for pertinent client information; in this disposition, it is receiving requests from clients or terminal computers and responding thereto according to the needs and capabilities thereof. In another embodiment, server system 102 is formed as a plurality of networked computers that together operate as a server as for example in the ubiquitous cloud system. Of course, there are other possible implementations that would still be within the scope of the concepts disclosed herein.

In order to effectively communicate across the network 100 to the fullest extent possible, the communication links provided by the network can be hardwired or wireless connections. Exemplary wired connections include but are not limited to: cable, phone line and fiber optic linkages whilst exemplary wireless communications include but are not limited to radio frequency (RF) and infrared (IR) transmission. Of course, there are many other wired and wireless connection that are known in various technologies that are employable in the implementation of the various novelties discussed herein.

As stated previously, within the servers 102 are found various applications generally referred to as software 105B working with hardware 105A to practice the novelties taught by A System and Method of Accounting/Tax Preparation Referrals. Amongst the software 105B are various software modules such as control software 106, referral links translation software 107, auditing software 108, modification software 109, video stream application software 110 and account management software 111.

### Software Modules 105B

It should be understood by the reader that in this disclosure, the words module, software or application are generally used interchangeably and are taken to mean a set of computer instructions that perform a particular task described more fully in the following.

Control Software 106 is the main organizer of various tasks and communicates over the hardware 105A to the network by receiving incoming requests for storing, retrieving, and updating information and sends commands to the various software modules and communicates across network 100. It coordinates communication between other software modules or applications as described below.

Referral Links Translation Software 107 interacts with the control software 106 to create, update and transmit links to CPAs tagged as SASBA CPAs, individuals which are to be tagged as RB Member—referral business members, RB Owners—referral business owners, centers of influence tagged as COI members, either directly or indirectly to and from the aforementioned persons through the control software 106.

Auditing & Analytics Software 108 interacts with the control software 106 permits a review of the current compensation awarded but not yet sent, awarded and mailed or electronically transferred to an individual, business, center of influence, and so forth (this feature can be alternatively folded solely into Account Management Software 111 or simply provides a second GUI for accessing this information). It also permits the transmission under control software 106 of targeted offers based upon the output of a particular user; thus, rewards, special benefits and the like. This module also facilitates learning about the effectiveness of current marketing efforts by providing statistics indicative thereof. Interacts with users either directly or indirectly through control software 106.

Modification Software 109 interacts with the direction of control software 106 to allow a software developer to enter the program and modify key coding components so as to facilitate the overall system. A testing suite is provided so as to ensure the capabilities and functions are operating within set design parameters expected therefrom. Interacts with users either directly or indirectly through control software 106.

Video Stream Software 110 interacts with the control software 106 to transmit a video stream from a dedicated video server as directed by the control software. Alternatively, it also operates in conjunction with the links translation software 107 to provide a link found on a public video site. Interacts with users either directly or indirectly through control software 106.

Account Management Software 111 interacts with the control software 106 to handle all initial subscriptions and it provides a page for managing various subscription levels. Control software 106 can direct account management software 111 to update, change or remove a particular group, individual, business or center of influence from the database. Changes can be of the demographic information such as name, address, or compensation level based upon given data provided by a user. Tags users as RB Owner, RB Business, SASBA CPA, COI and stores that in a storage space in the server 102. Further, it should be understood that each tag represents a specific signature either alone or in combination with another tag. Finally, the account management software 111 that stores these alternatively works alone or in combination with control software 106 (or control software 106 alone) to store these in table of FIG. 1C.

The aforementioned application software can be deployed as necessary in one or more servers either in whole or in part where the software and associated data is distributed across several servers. Thus, a single computer acting as a server could have all of these software modules or only a portion thereof; in this latter instance, the particular computer would rely on other members of the system to perform the additional distributed functionality. Similarly, a group of computers acting as a server could have all of these software modules or only a portion thereof, relying on other groups of computers acting as a single server to perform said functionality. It should be understood that the various software modules described herein interact together with appropriate codewords indicative of the specific performance required.

The data stored on the server represents the application software necessary to accomplish the goals herein described and the demographic (Name, Address, Phone Number, Email, Social Links) and compensatory relationship between SASBA and the individual, CPA or center of influence COI who has joined. When a member signs up as a Referral Business Member they are set up in Customer Relationship Management CRM software using the Account Management Software 111 with a tag of RB, that is a referral business RB. This and other tags allow for targeted and automated email to different groups at the appropriate time. In this disclosure, there are several tags: these are namely, RB Member (typically reserved for individuals who want to take advantage of the tax benefits herein described), SASBA CPA, RB Owners Member, Centers of Influence COI (such as SASBA CPAs, RB Members, RB Owners, Associations, Trade groups). A referral data and or signature table 112 has the various demographic information described above as well as the various tags pertinent to each user as he or she signs up, is updated or deleted as appropriate to the ongoing relationship to SASBA. This referral data and or signature table 112 stored on referral server 102 is more clearly shown in FIG. 1C.

FIG. 1B presents a view of various components utilized in the System and Method of Accounting/Tax Preparation Referrals in an embodiment disclosed herein. In order to facilitate the automation of this patent, there are various components of the processes. SASBA currently uses a software called InfusionSoft′ that has most of these components within their platform. Like most software systems, the user has to program the system to accomplish the needed tasks for the process. Below is a brief description of each of these software components that are utilized.

CRM—Customer Relationship Management. CRM software is a category of software that covers a broad set of applications designed to help businesses manage various business processes including:
a. Customer data (name, address, email address, phone number, etc.)
b. Customer interaction including documentation of phone calls and emails
c. Track customer's attributes through tags such as ‘SASBA CPA,’ ‘Referral Business Member,’ ‘Referral Business Owner,’ Center of Influence, ‘Social media contact,’ etc.

Personalized Tracking Links (PTL)—Tracking URLs are essential tools that allow SASBA to determine which Center of Influence Member directed traffic to the landing page for the individuals that join the Referral Business program. This is the feature of the software which tracks the information needed to pay the proper individual for referrals. This is an example of programming needed to determine who gets credit for the referral when two COIs send the PTL to the same individual. The PTL is a specialized link having personal information that when coded into an email or web page points to a landing page using ordinary HTML or similar internet related code.

Referral Partner or Affiliates—InfusionSoft calls this area of the software—Referral Partner. This component coordinates the PTL, Hierarchy, Subscription, and Accounts Receivable components. Other software is available and is generally called the Affiliate area.

Hierarchy—In order to increase the amount of income to the Referral Business member, SASBA has programmed InfusionSoft to not only pay on the member's enrollee but also on the subsequent level of enrollee. The system has to be programmed to compensate Referral Partner/Affiliate a certain amount for each of their enrollees and subsequent levels.

Campaigns—Marketing automation makes it easier to send personalized, targeted messages at the appropriate time (immediately after joining, five days after joining, etc.). Proper tagging (Referral Business Member/Owner SASBA CPA, COI Member) is essential for this component.

Subscription—This feature of the software automates the collection of monthly fees from the Referral Business members. InfusionSoft has this feature only from the drafting from Referral Business Member's credit cards. In the future SASBA anticipates there will be a need to have the capability to draft the fees from the members' bank accounts. This a feature that InfusionSoft does not presently supports.

Accounts Receivable—InfusionSoft computes the amount which SASBA owes the Referral Business Members and owners from information in the Subscription, Hierarchy, and Referral Partner modules.

Center of Influence—COIs are the referral business members, referral business owners or SASBA CPAs that have signed up to become a COI. Upon becoming a COI they receive their personal tracking links (PTLs). The purpose of the COI tag is to provide them with targeted emails with links to videos training them on using their personal links (PTLs).

FIG. 1C presents a view of a Referral Space Table in the System and Method of Accounting/Tax Preparation Referrals in an embodiment disclosed herein. A referral data and or signature table 112 has the various demographic information described above as well as the various tags pertinent to each user as he or she signs up, and is updated or deleted as appropriate to the ongoing relationship to SASBA. Various exemplary users are shown in the figure having Name address and tags associated therewith. It should be appreciated that other information is also stored therein but is omitted for simplicity. For example, email, telephone, social media contact information, group membership, trade associations and so forth are also optionally stored but are not included to highlight the tags or signatures data or datum relevant to the instant application.

As the examples therein show each person has a Name Field along with an Address field as well as the fields not shown but described above. These are filled out as necessary according to the availability of the information supplied to SASBA. Additionally, there is a tag or signature data or datum field which has one or more tag(s) and or signature(s) relating to the association to SASBA. Thus, a user can be a SASBA CPA, a RB Owner or a RB Member depending upon whether or not he or she is a CPA, a business owner already or a non-business owner who would like to qualify as a business for IRS regulations as previously described. Additionally, in the course of the setting up the Referral Table, the person can also have a Center of Influence tag COI.

As an example of a SASBA CPA we have:

John Q. Public 4477 Sunshine Way Orlando, Fla. 32817

who has already has a signature or tag of SASBA COA and a COI signature or tag.

As an example of a RB Owner we have:

Susan Applebee 1177 Campaign Court, Tampa Fla. 33801

who has already has a signature or tag of RB Owner and a COI signature or tag.

As an example of a RB Member we have:

Randal Clooney 3355 White Ln, Palm Beach FL 33801

who has already has a signature or tag of RB Member and a COI signature or tag.

5-Step Marketing Plan—This plan comprises an overall strategy to improve the success of your referrals in an accounting and tax preparation business. The referral strategy has a Unique Value Proposition in the basic steps of:
a. Begin Program by Sending an Email
b. Receive New Contacts from Emails
c. Read Book, The Referral of a Lifetime by Tim Templeton
d. Find your Major Business Advocates; i.e., those that are going to further your business goals
e. Work with your Major Business Advocates to improve the results of the marketing.

### SASBA Goals

It should be appreciated that SASBA's goal is to offer each and every taxpayer the opportunity to benefit from the unique tax advantages of running a business with no direct selling, no inventory, and almost no upfront costs. Additionally, Certified Public Accountants (CPA) are considered by most as trusted financial advisors; SASBA uses this to its advantage by initiating the referral business plan with CPAs. Thus, CPAs are initiated into the system and if they agree to join they are tagged as a SASBA CPA. Because a CPA's clientele is there for sound advice, these are perfect targets of the referral business plan; thus, the SASBA method will immediately engage a group of members who are convinced of the effectiveness of the strategy described herein.

For those individuals who have no business, a SASBA CPA can direct them through emailed referral links to go the referral business plan landing page and thus, the SASBA CPA can earn compensation from SASBA for new referrals; alternatively, they can signup themselves if they land on the SASBA website and join there. Additionally, once signed up, the individual becomes a Referral Business and gets tagged as RB and gains the tax advantages of a business, receives discounted returns, and gets compensation if and when they refer new business from emailed links and more.

Finally, trade associations, businesses, trade groups and similar organizations will join and become an RB owner and are tagged as an RB owner. They are then sent a link to sign up as a COI. Once becoming a COI, they receive their personalized tracking link for signing up new members. Thus, the SASBA method has four tags, and these are namely, SASBA CPA, RB Member, RB Owner, and COI.

### SASBA Method

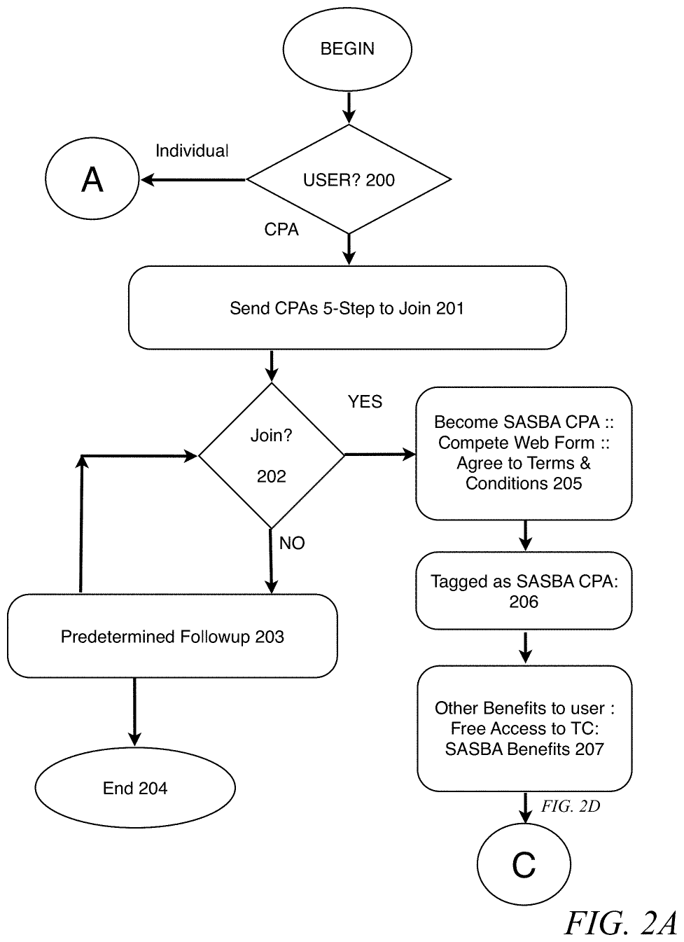

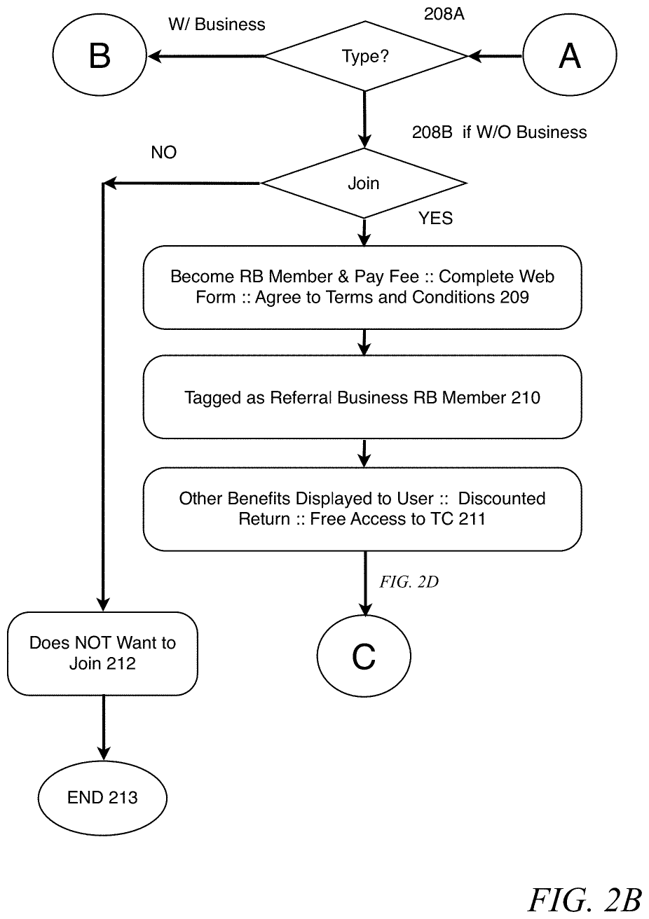

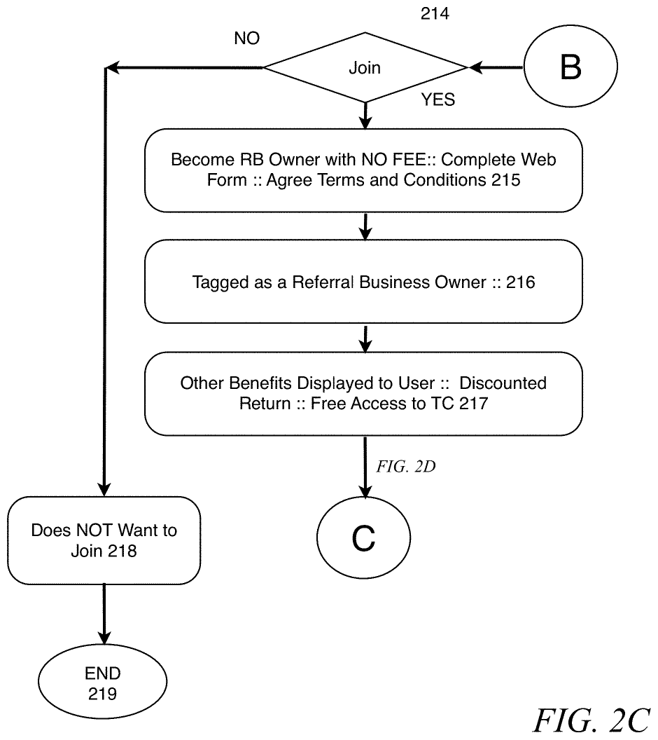

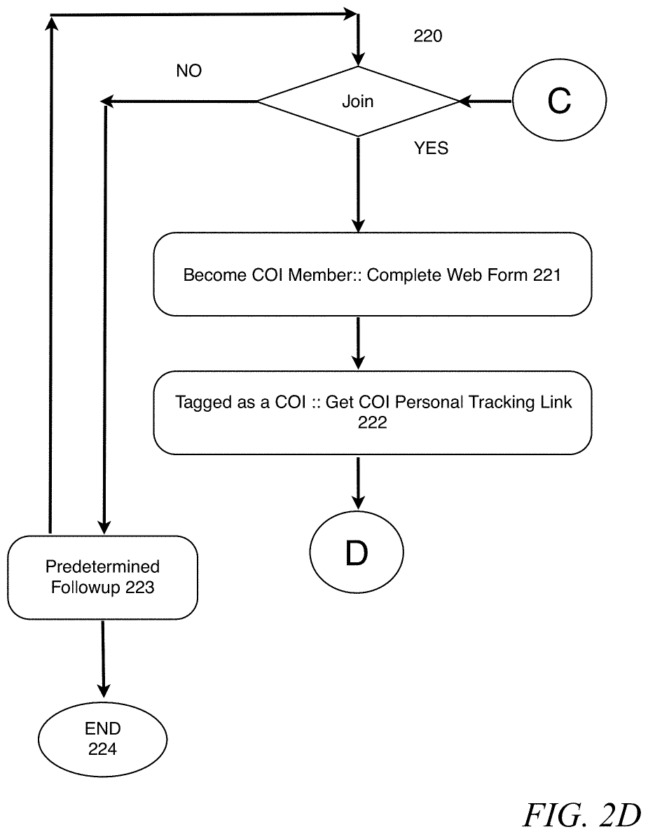

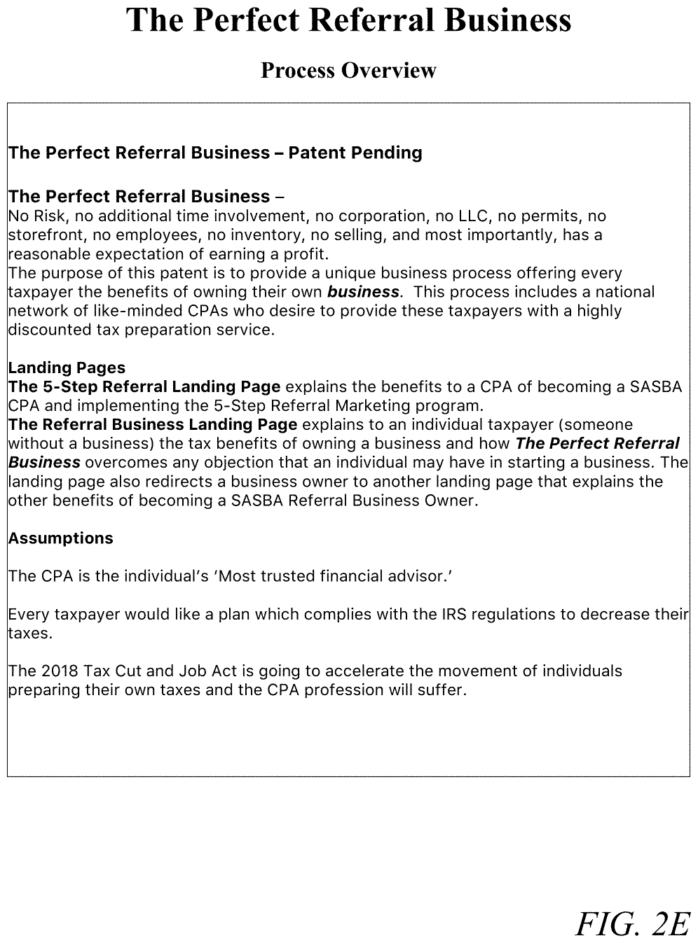

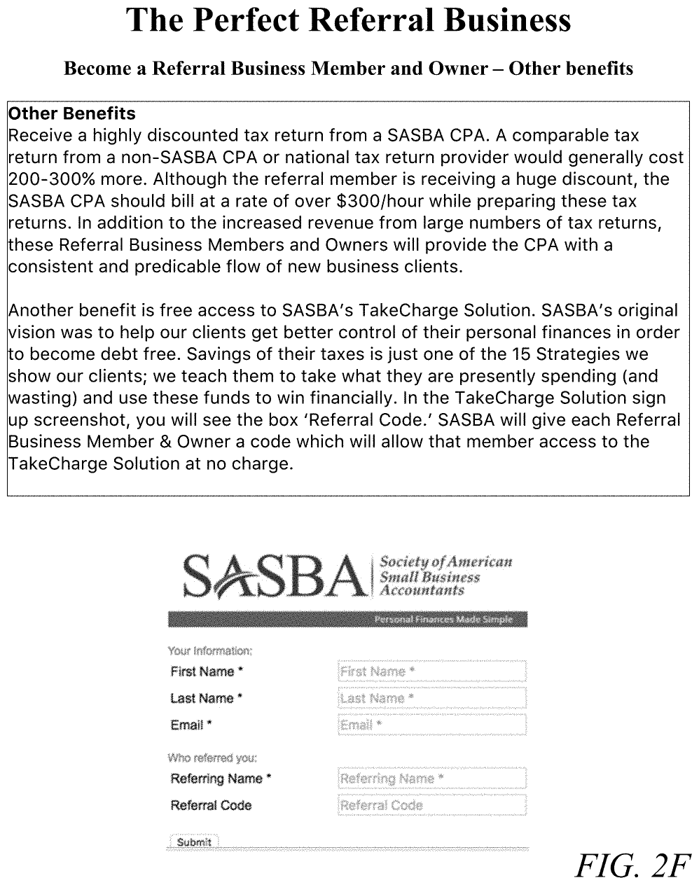

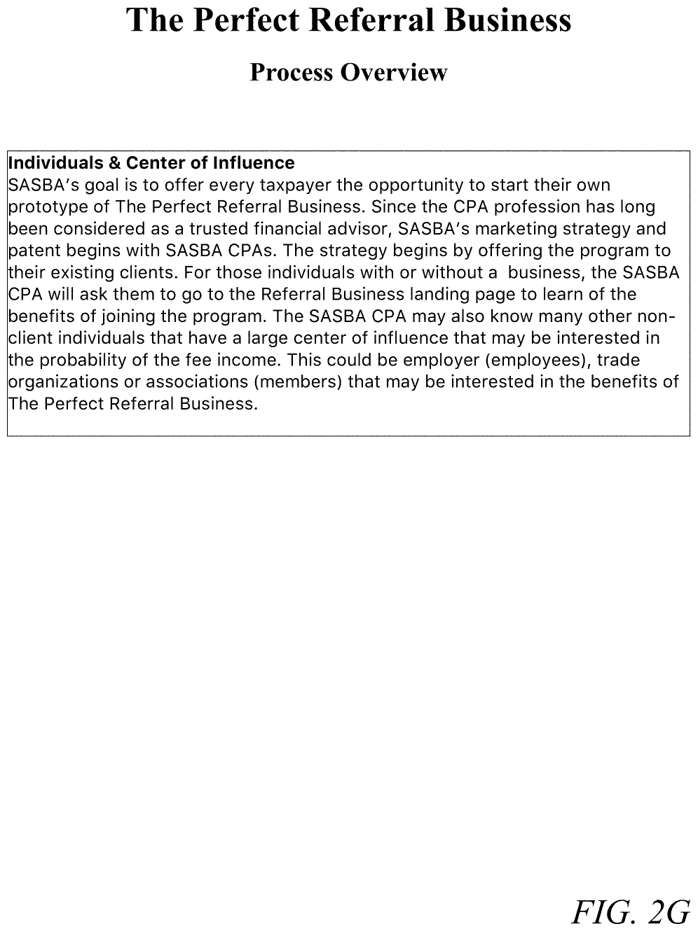

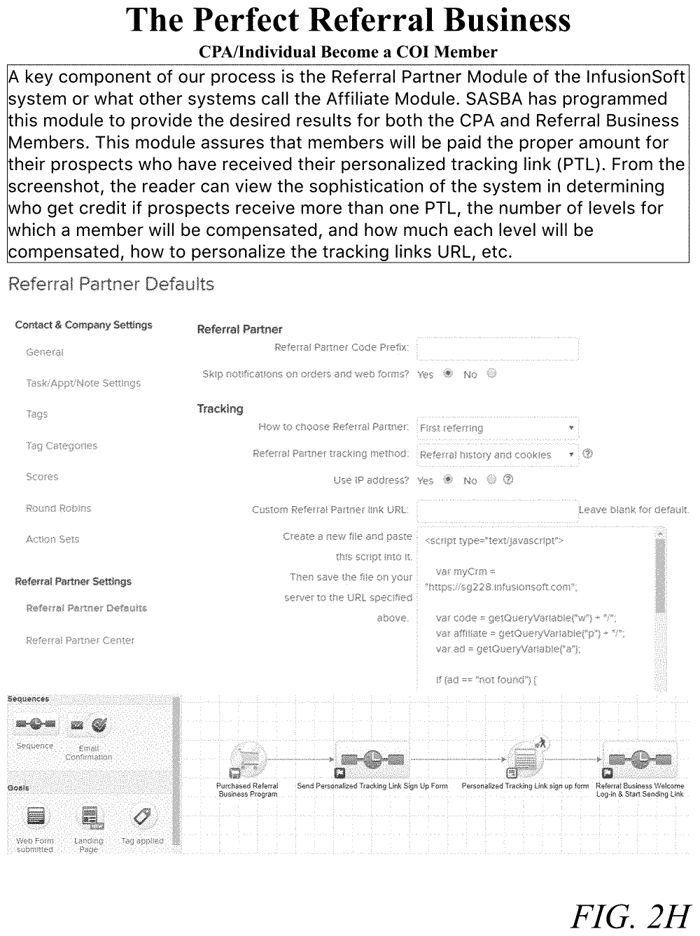

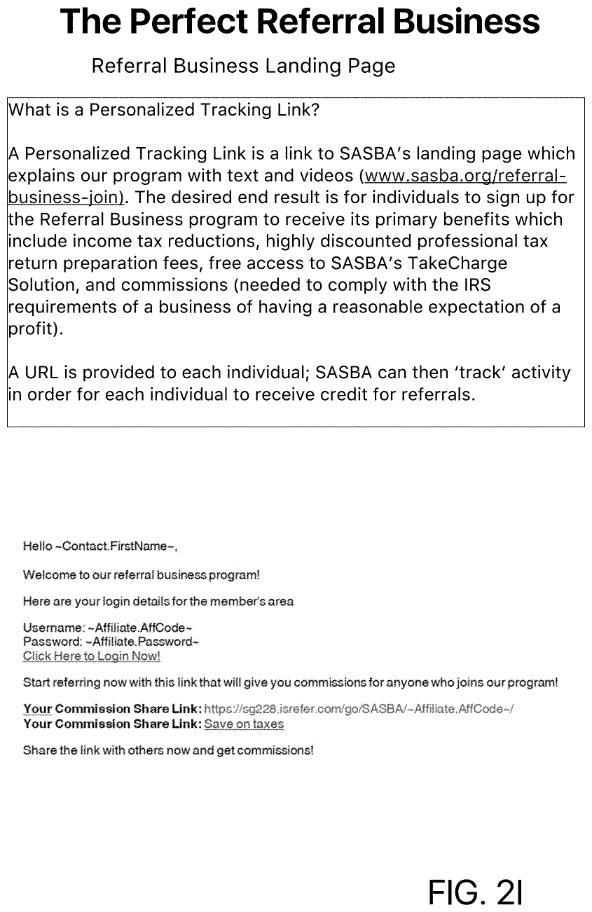

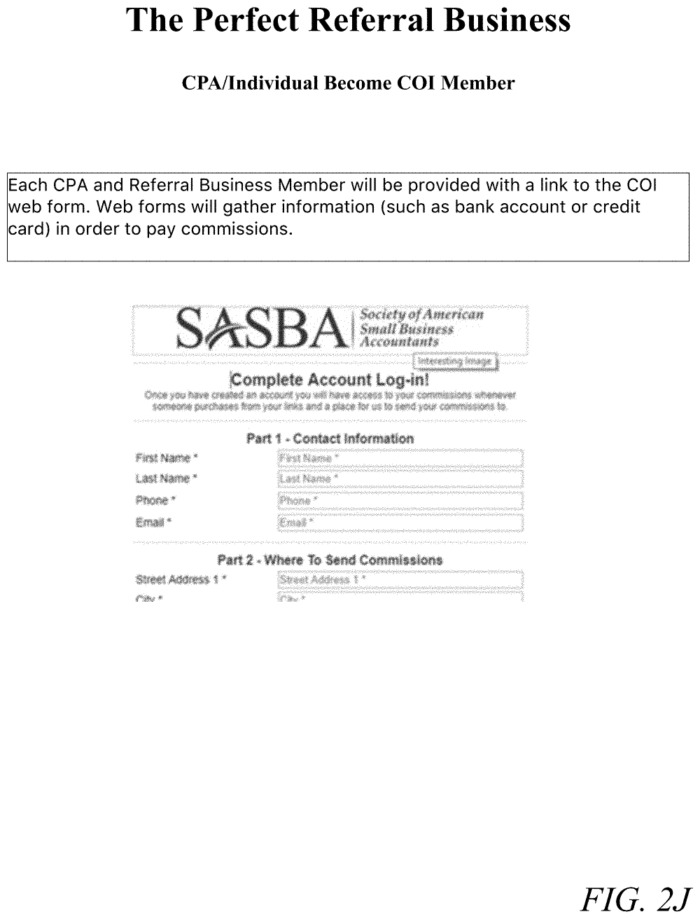

FIG. 2A-2D presents a High Level Process Flow Diagram of a System and Method of Accounting/Tax Preparation Referrals in an embodiment disclosed herein. This system and method provides for a no-risk, little or no additional time involvement, no corporation, no LLC, no permits, no storefront, no employees, no inventory, no selling, and most importantly, it has a reasonable expectation of profit. As stated previously, IRS regulations states that generally an activity is considered a business if it has a reasonable expectation of profit. Thus, this system provides a method by which individual users can advantageously become a business for IRS tax purposes without a great deal of effort, work and with virtually no financial investment.

In order to fully appreciate the novelties herein, the system of FIG. 1A and the process disclosed in FIG. 2A-2D et seq. it is instructive to understand some of the terms used in the discussion thereof. Thus, acting as a lexicographer, the instant disclosure defines certain terms that are to be used throughout the disclosure of the concepts herein as follows:
a. 5-Step: 5-Step Referral Marketing Plan
b. SASBA: Society of American Small Business Accountants
c. Individuals: Taxpayers without a business
d. TC: TakeCharge Solution
e. RB: Referral Business
f. RB Member: Individual without a business
g. RB Owner: Someone with an existing business
h. CPA: A Certified Public Accountant or someone with comparable income tax preparation and/or accounting experience.
i. PTL: Personalized Tracking Link: a specialized link have specific parameters that identify an entity and links to a landing page using network rules; the landing page itself is typically hidden whilst the PTL is visible; alternatively, the reverse is true.
j. Landing Pages:
   i. For CPAs: www.sasba.org/5-step-referral-join
   ii. For Individuals: www.sasba.org/referral-business-join
   iii. For All: www.sasba.org/takecharge

FIG. 2A presents a High Level Process Flow Diagram of a System and Method of Accounting/Tax Preparation Referrals in an embodiment disclosed for the introductory process and for the membership of a tagged SASBA CPA. The System and Method of Accounting Referrals begins by determining what type of user is signing up at step 200. This information is determined by a set of links on a landing page of a web site (for web browser applicants) where each link represents a single one of a group of options such as CPA (SASBA CPA) and Individuals. As we will see individuals are further sub-divided into Individuals without a business (Referral Business: RB Member) and Individuals with an existing business (Referral Business Owner: RB Owner); this all can also be predetermined by sending an email to known users who respond to unique links representative of SASBA CPA, RB Member or RB Owner therein to a web site landing page pre-established for their type of relationship with SASBA.

In any case, the server either has this predetermined information from mailing lists, social media information, or web browser applicants clicking one of the aforementioned options or it receives the parameters describing the type of user from an emailed link (sent by control software 106 or InfusionSoft software in an introductory email) being clicked by the intended recipient. For SASBA CPAs the software continues to step 201. However, if the person is a Referral Business Member (RB Member, someone without an existing business but NOT a CPA) or a Referral Business Owner (RB Owner, someone with an existing business but NOT a CPA) the software follows the point ‘A’ shown in FIG. 2A to its continuation shown in FIG. 2B point ‘A.’

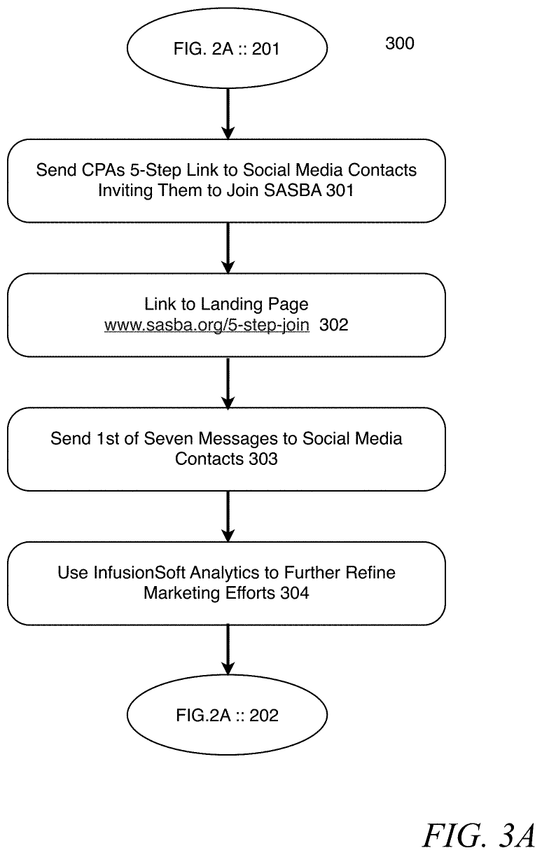

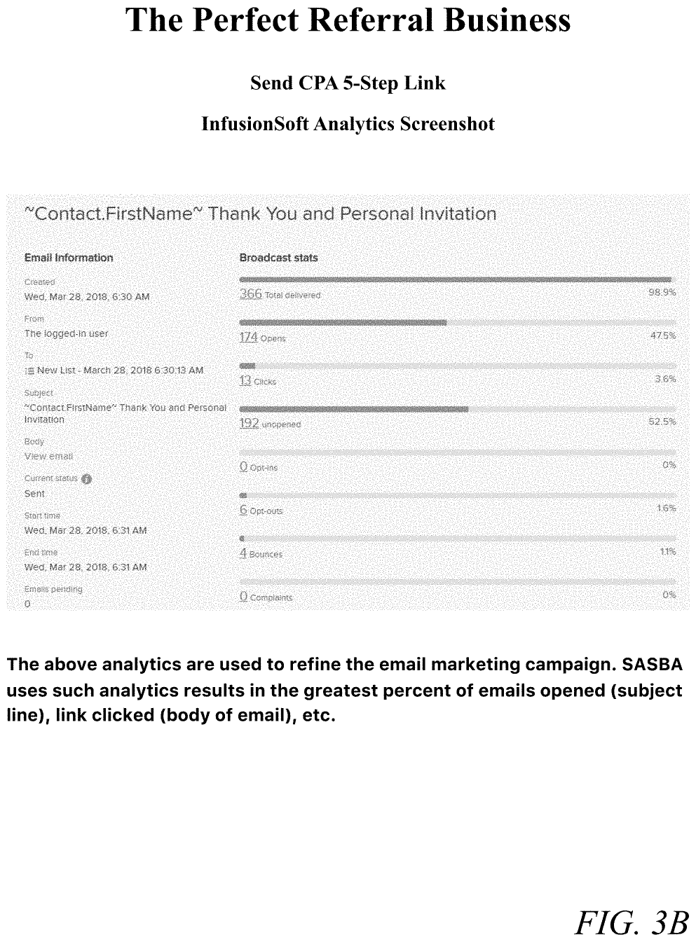

In the event the user is a CPA 201, the process sends CPAs a ‘5-Step’ (five step refers to a strategy but the link is simply a hyperlink to a website page or private server link) link having a message to join the referral marketing plan (an alternative embodiment of FIG. 3A shows this in another perspective). This link is to be sent to multiple contacts, for example, LinkedIn™ contacts inviting them to join SASBA, so that they can proceed to the SASBA landing page for CPAs. This first introductory email message and link represents the transmission of a first of several messages to the contacts. In order to accomplish this goal, the process uses dedicated control software alone or in combination with a tool such as InfusionSoft™ to further marketing efforts. In particular, the InfusionSoft™ program is presently the control software 106 substitute in one implementation of the novelties taught herein; this product provides Customer Relationship Management CRM, automated marketing, subscription support, affiliate assistance and more.

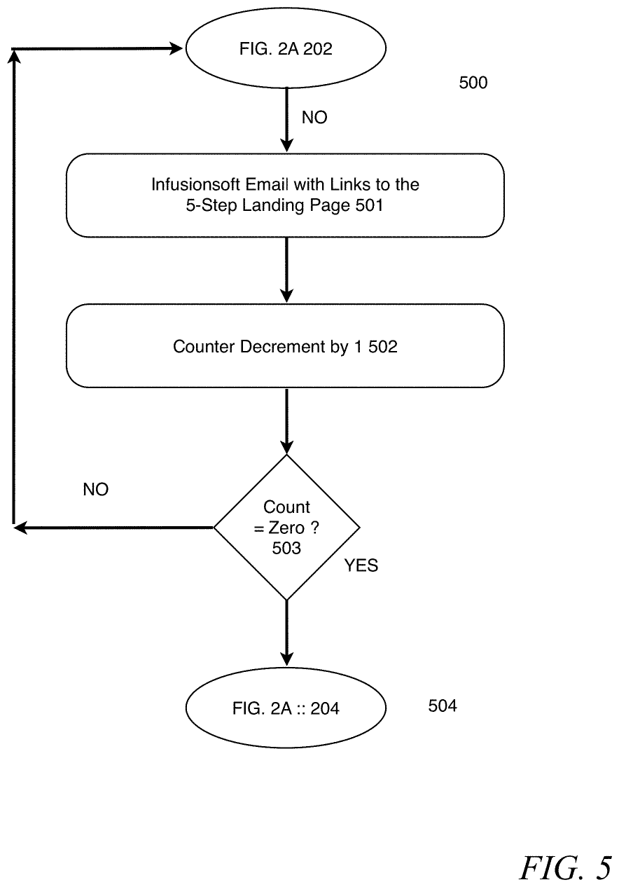

By clicking the link in the introductory email (or signing up by web browsing to the SASBA site and clicking a CPA user link) a user communicates his desire to join or not join SASBA (a remove me from the list link is also provided in the email along with the join link) and the control software 106 receives this information and calls the account management software 111 to determine 202 the state of the situation data received. In the event that a user (SASBA CPA) does not wish to join SASBA as he or she has not responded (or a remove me link request is received from the remove me link), the control software 106 informs the account management software 111 to send a followup communication 203 as shown more completely in FIG. 5; alternatively, the account management software 111 informs the control software 106 which software transmits this email to the user again.

As further described with respect to FIG. 5, an attempt is made by the account management software 111 (alone or in combination with control software 106 or alternatively the control software 106) to transmit another request to join. In the event the user (SASBA CPA) receiving these links joins, then the control software 106 receives this information and informs the account management software 111 to register this fact including all relevant demographic information such as name, address, professions, email address, phone number, level of service and so forth. If after a predetermined number of requests are sent a user (SASBA CPA) does not join then the process ends at 204.

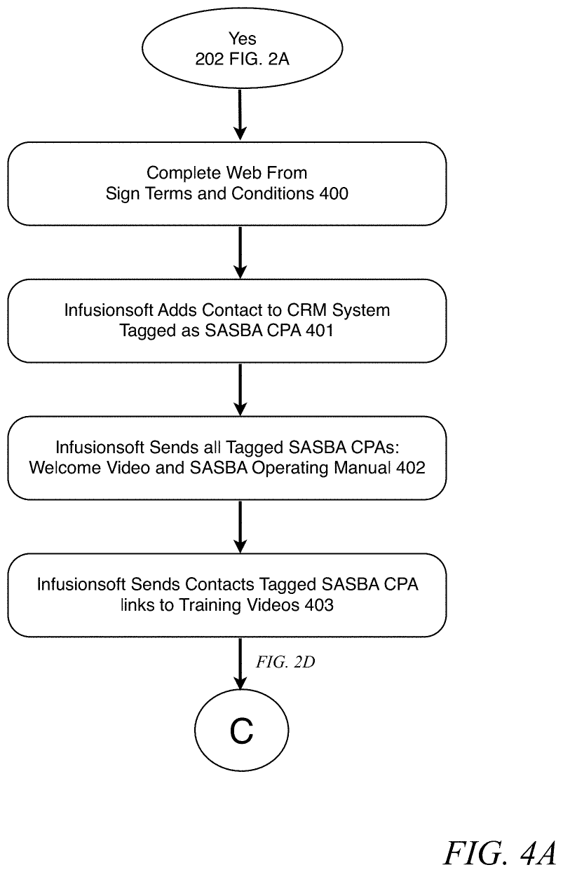

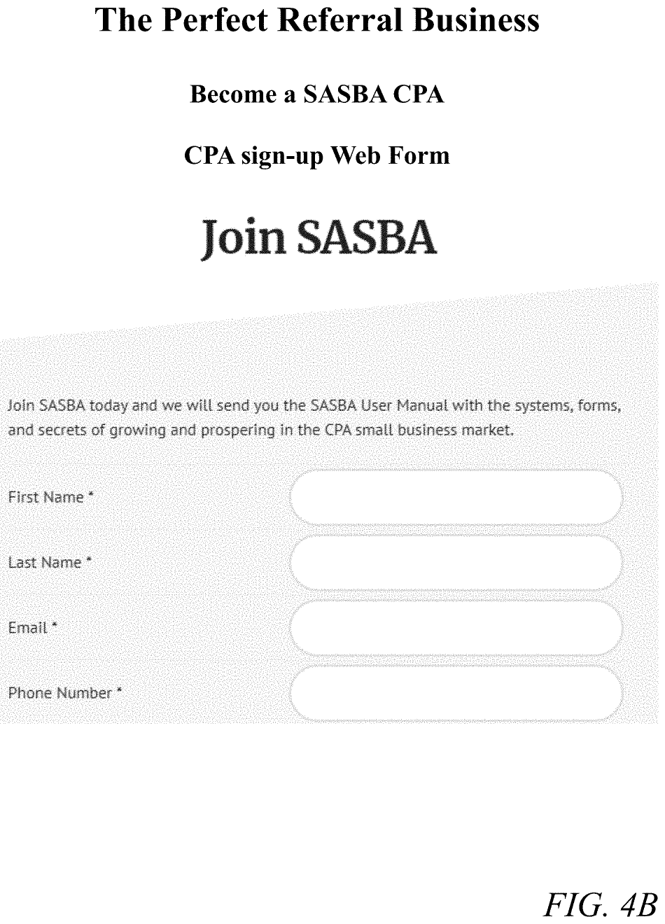

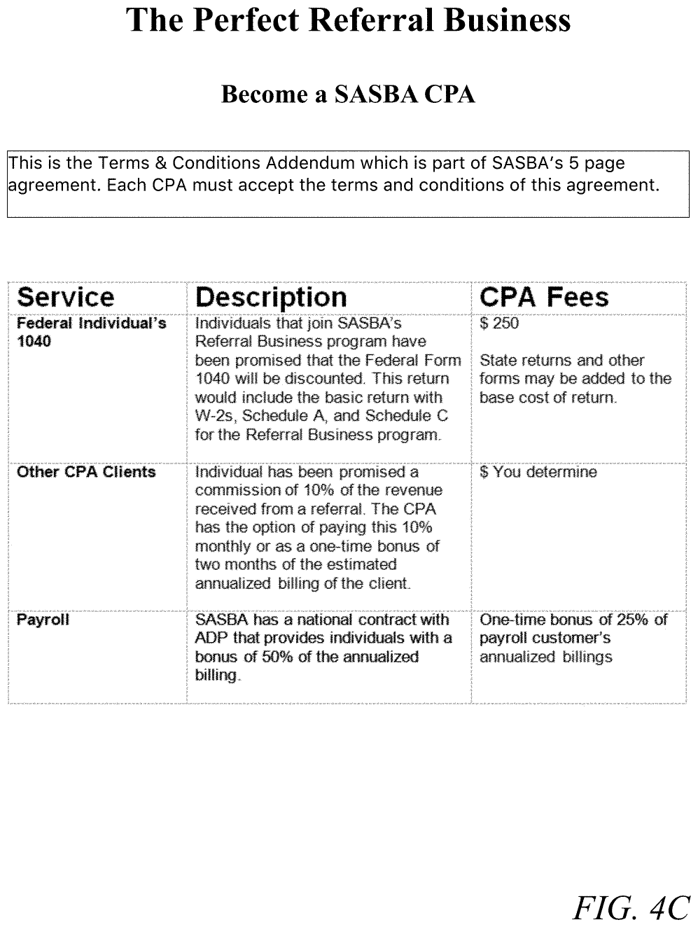

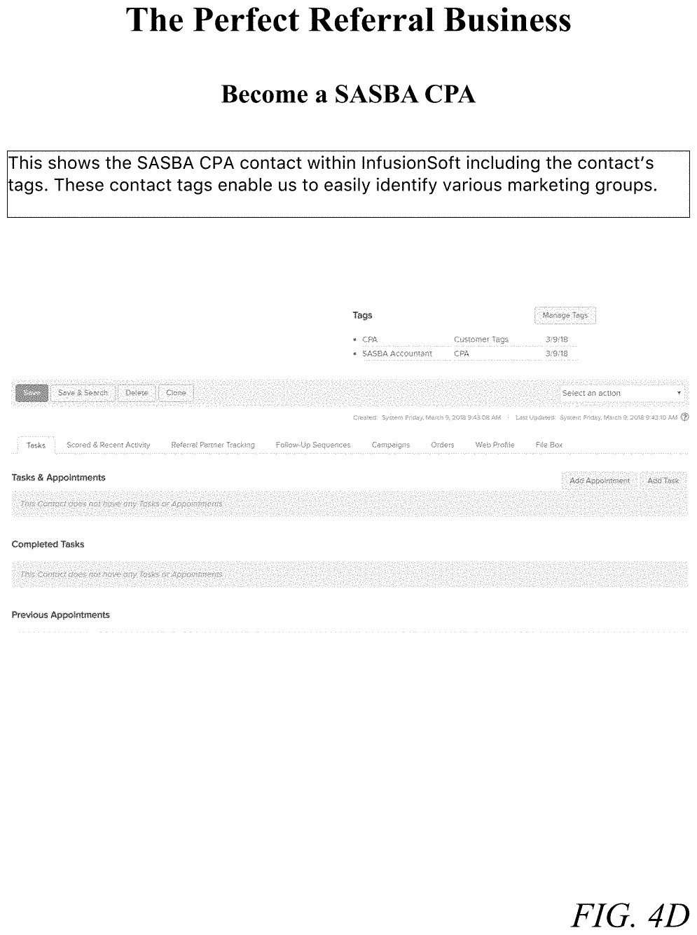

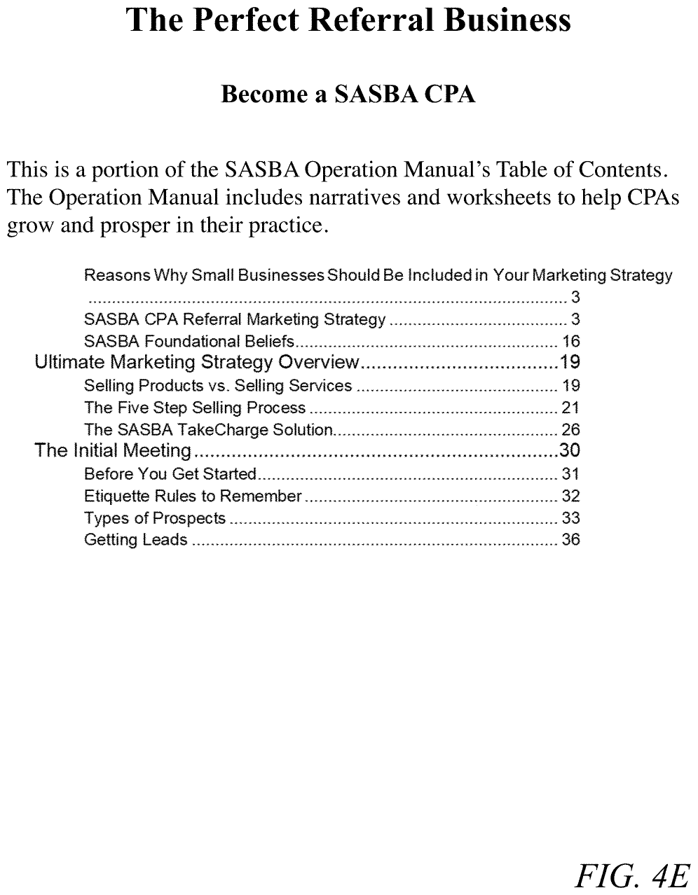

In the event that a user (SASBA CPA) wishes to join SASBA, the user accepts the possibility of membership by clicking a sign up link that when activated is sent back to the SASBA server and processed by the control software 106. This fact is communicated to the account management software 111 at step 202 by control software that decides to proceed with the membership application as shown in step 205 and more fully described in an alternative embodiment with reference to FIG. 4A.

First, the control software 106 directs the account management software 111 to present 205 a web application form. Then the user fills out the form including but not limited to: Name, Address, Phone, Email, Social Media Information and so forth; this user sent information is received by processor in the SASBA server and the account management software 111 stores this thereby as a profile in the database. After this, the applicant has now officially become a SASBA CPA and so the corresponding SASBA CPA is now tagged 206 by account management software 111 adding this to the profile in the database. At this point, other benefits are presented to the user such as the TakeCharge solution 207. Next, the process continues to point C which continues in FIG. 2D at a corresponding point labeled C.

Regarding the alternative embodiment of FIG. 4A, most generally, the applicant: completes a sign up form and accepts the terms and conditions of SASBA. The account management software 111 (or CRM system) tags the CPA with a SASBA CPA′ tag and stores this tag signature information in the database storage. InfusionSoft or control software 106 sends all CPAs a linked welcome video and a manual that are transmitted to the SASBA CPA. Further, InfusionSoft or control software 106 sends SASBA CPA links to training videos. Alternatively, the control software 106 call video stream software 110 to transmit a video stream popup to the user or in conjunction with links translation software to email a link to the video to the user.

The process continues showing in audio, video, and or text how the personalized tracking link (PTL) overcomes objections to time involvement, selling anything, a reasonable expectation of profit and any other common objection starting a business. Finally, the landing page shows how SASBA provides a powerful postscript to the system in audio, video and or text that highlights how the SASBA personal tracking link can be sent with a catchphrase “My CPA showed me a way I could save money on my taxes. I thought you may want to take a look yourself” (send your personal tracking link) SASBA's primary goal is to offer each and every taxpayer the opportunity to benefit from the unique tax advantages of running a business with no direct selling, no inventory, and almost no upfront costs.

Returning to decision diamond 200 in FIG. 2A the process forks into another potential branch, namely, individuals that proceeds to decision point A of FIG. 2B. The process for individuals continues with decision point A of FIG. 2B that starts at step 208A having branches for types of individuals without a business and those that are business owners. Those without a business can become a RB Member in FIG. 2B whilst the process for individual business owners is described with respect to FIG. 2C.

FIG. 2B presents a High Level Process Flow Diagram of a System and Method of Accounting/Tax Preparation Referrals in an embodiment disclosed herein for the membership of someone without a business who wants to become a tagged Referral Business RB Member. Thus, for individuals, the process continues in FIG. 2B at point A received from FIG. 2A 200, where either through web surfing, an emailed link or similar modality those who do or do not have a business (and are NOT a CPA) are directed to go to the referral business plan landing page.

Here a link on a page (or question box with two responses) is for those who do have a business already (potential Referral Business Owner: RB Owner) or for those who do not have a business (potential Referral Business Member: RB Member) and a short description is described next to the link for this page for each so that a user can select the appropriate category. Thus, the control software 106 receives a decision as to type 208A of user and this is registered and control software 106 calls up account management software 111 to process the new registrant (alternatively, the control software 106 had already called the account management software 111 to handle this entry directly). For those who already have a business (potential Referral Business Owner: RB Owner) the process proceeds to point ‘B’ where it flows to FIG. 2C, 214. For those who do not have a business (potential Referral Business Member: RB Member) the process proceeds to asking them formally whether or not they wish to join 208B.

When they agree to become a Referral Business Member, the system uses account management software 111 under direction of control software 106 to present and store demographic information in the server database when it receives a completed web form (Name, Address, Email, Phone, Social Media information) from the user who agrees to terms and conditions 209 (this helps them meet the IRS constraints of starting a business by gaining a future PTL and transmitting to other users with the expectation of being compensated by SASBA); a fee is taken after this information is stored.

As a result of signing up, the account management software 111 tags an individual user as a RB member 210; the system uses account management software 111 under direction of control software 106 stores this tagged information Referral Business member in the server database for the appropriate individual. The process continues with the email transmission 211 of benefits of SASBA either in an email page or in a link to a web page or in a downloaded file (PDF, TXT, DOC etc.) showing various additional features of the program such as highly discounted tax return, free access to TakeCharge solution. The process continues at point ‘C’ to a similar point ‘C’ in FIG. 2D.

In the event an individual potential RB Member has chosen not to sign up at step 208B, then this means that the potential RB Member is rejecting membership offer 212. As a result, the process ends 213.

FIG. 2C presents a High Level Process Flow Diagram of a System and Method of Accounting/Tax Preparation Referrals in an embodiment disclosed herein for the membership of someone with an existing business who wants to become a tagged as a Referral Business Owner. The process starts from FIG. 2B point ‘B’ that continues to FIG. 2C point ‘B.’ Thus, the process continues in FIG. 2C where either through web surfing, an emailed link or similar modality individuals who already have a business are directed to go to the referral business plan landing page where they are asked whether or not they wish to join 214. If they decided to join SASBA as a RB Owner then demographic information is taken from the aforementioned as shown in the web form in FIG. 2F.

When they agree to signup the system uses account management software 111 under direction of control software 106 to store this information in the server database when they complete a web form and agree to terms and conditions 215. As a result of signing up, the account management software 111 tags 216 the user as a Referral Business Owner by giving it the RB Owner tag; the system uses account management software 111 under direction of control software 106 stores this tagged information in the server database.

It should be understood that account management software 111 has understood that the business owner has chosen to be tagged as a Referral Business Owner in the server database. The process continues with the transmission 217 of other benefits of SASBA either in an emailed page, downloaded form or in a link to a web page showing various additional features of the program such as highly discounted tax return, free access to a TakeCharge solution. At this point the process proceeds to point C in FIG. 2D. However, in the event a business owner has chosen not to sign up at step 214, this is a signal that the potential RB Owner does not wish to be part of the system 218. At this point, the process branch ends at step 219.

FIG. 2D presents a High Level Process Flow Diagram of a System and Method of Accounting/Tax Preparation Referrals in an embodiment disclosed herein for acceptance of membership as a tagged Center of Influence COI. Point C from FIG. 2A, 2B, 2C transits to point C in FIG. 2D. Here another query 220 is made as to whether or not a user wishes to become a Center of Influence. In the event that a user wants to become a center of influence and be tagged as such, a web form is presented 221 to the user from information stored of the server and presented across the network by control software 106.

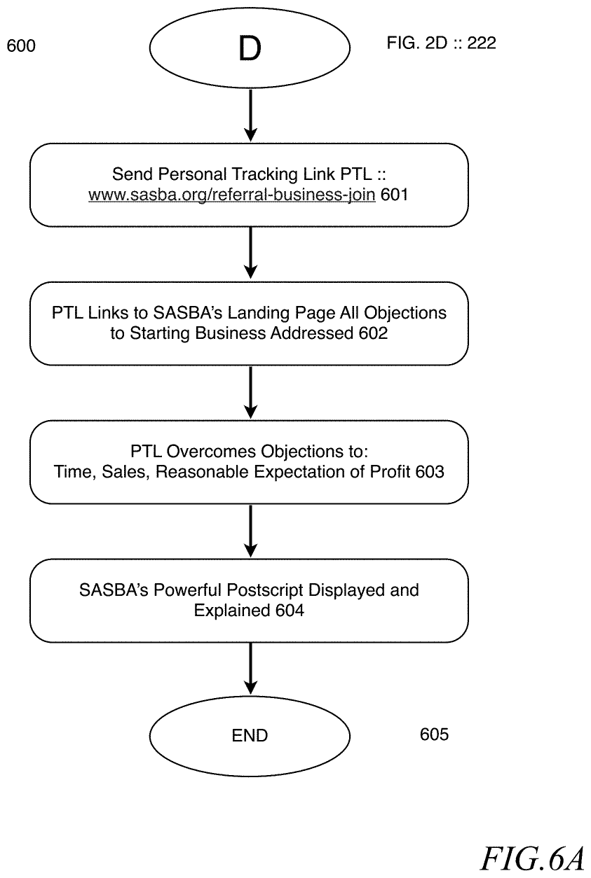

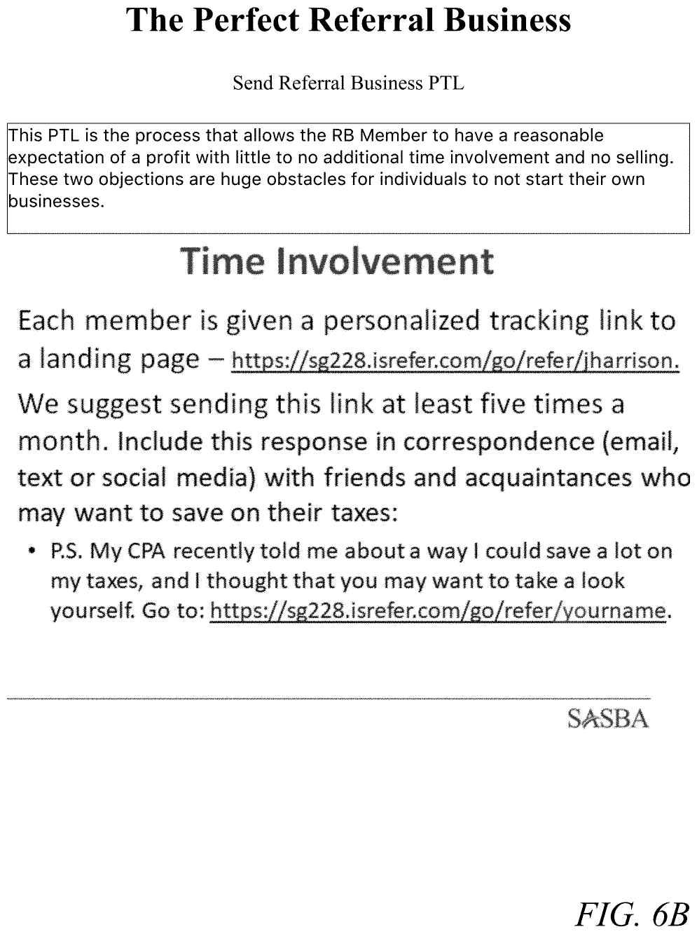

Any other personal or demographic information relating to associations, trade groups, unique emails, social addresses and so forth are collected at this time by the account management module 111 and stored in server 102 by control software 106 or account management software 111 or combination of the 106 and 111. Finally, the account management module 111 tags 222 the user as a center of influence (COI) and this information is stored in the server database appended to the other tags the user can have such as: SASBA CPA, Referral Business Owner (RB Owner), or Referral Business Member (RB Member) information; then the control software commands the link translation software 107 to generate a 222 Personalized Tracking Link (PTL) for the user. At this point the process proceeds to point D which is to be continued in FIG. 6A point D at the top of that page.

FIG. 2E presents a Process Overview as disclosed in an embodiment herein described. In particular, The Perfect Referral Business is a No Risk, no additional time involvement, no corporation, no LLC, no permits, no storefront, no employees, no inventory, no selling, and most importantly, has a reasonable expectation of earning a profit. The purpose of this patent is to provide a unique business process offering every taxpayer the benefits of owning their own business. This process includes a national network of like-minded CPAs who desire to provide these taxpayers with a highly discounted tax preparation service.

Landing Pages

The 5-Step Referral Landing Page explains the benefits to a CPA of becoming a SASBA CPA and implementing the 5-Step Referral Marketing program. The Referral Business Landing Page explains to an individual taxpayer (someone without a business) the tax benefits of owning a business and how The Perfect Referral Business overcomes any objection that an individual may have in starting a business. The landing page also redirects a business owner to another landing page that explains the other benefits of becoming a SASBA Referral Business Owner.

Assumptions

The CPA is the individual's ‘Most trusted financial advisor.’ Every taxpayer would like a plan which complies with the IRS regulations to decrease their taxes. The 2018 Tax Cut and Job Act is going to accelerate the movement of individuals preparing their own taxes and the CPA profession will suffer.

FIG. 2F presents a group of advantages and additional benefits to the SASBA System and Method of Accounting/Tax Preparation Referrals in an embodiment disclosed herein. In particular: a) one can receive a highly discounted return as a member; b) gain free access to a TakeCharge fifteen (15) point strategy for better controlling the state of finances for a debt free lifestyle starting with tax savings; and c) reduction in overall tax return preparation fees, as a comparable tax return from a national tax company would still be 200-300% higher than the SASBA CPA who can still charge about $300/hr. for the preparation of this type of return. For a SASBA CPA the additional revenue of a large steady stream of tax returns thereby provides a steady stream of predictable cashflow. InfusionSoft™ software or control software 106 provides a code to each member for accessing the TakeCharge Solution. Also shown is a web form having the signup page when one has decided to join in a simple implementation thereof.

FIG. 2G presents a block diagram of the process flow whereby various Individuals and Centers of Influence are targeted for correspondence in an embodiment of the System and Method of Accounting/Tax Preparation Referrals as disclosed herein. SASBA's goal is to offer every taxpayer the opportunity to start their own prototype of The Perfect Referral Business. Since the CPA profession has long been considered as a trusted financial advisor, SASBA's marketing strategy and patent begins with SASBA CPAs. The strategy begins by offering the program to their existing clients. For those individuals with or without a business, the SASBA CPA will ask them to go to the Referral Business landing page to learn of the benefits of joining the program. The SASBA CPA may also know many other non-client individuals that have a large center of influence that may be interested in the probability of the fee income. This could be employer (employees), trade organizations or associations (members) that may be interested in the benefits of The Perfect Referral Business.

FIG. 2H presents a Referral Partner Module screenshot in one implementation of the SASBA System and Method of Accounting/Tax Preparation Referrals in an embodiment disclosed herein. In this particular alternative implementation or embodiment, a key component of the process is the Referral Partner Module of the InfusionSoft system or what other systems call the Affiliate Module. SASBA has programmed this module to provide the desired results for both the CPA and Referral Business Members. This module assures that members will be paid the proper amount for their prospects who have received their personalized tracking link (PTL). From the screenshot, the reader can view the sophistication of the system in determining who get credit if prospects receive more than one PTL, the number of levels for which a member will be compensated, and how much each level will be compensated, how to personalize the tracking links URL, and so forth. The tracking links can be manually generated or generated automatically using the name of the member or a unique pseudo random number code or a combination of the aforementioned.

FIG. 2I presents a diagram explaining what a personalized tracking link and also a portion of a short email that is sent to each COI having username, password and various share links in an embodiment disclosed herein. What is a Personalized Tracking Link? A Personalized Tracking Link is a link having personalized information for compensation purposes to SASBA's landing page (www.sasba.org/referral-business-join) which explains our program with text and videos. The desired end result is for individuals to sign up for the Referral Business program to receive its primary benefits which include income tax reductions, highly discounted professional tax return preparation fees, free access to SASBA's TakeCharge Solution, and commissions (needed to comply with the IRS requirements of a business of having a reasonable expectation of a profit). A URL is provided to each individual; SASBA can then ‘track’ activity in order for each individual to receive credit for referrals.

FIG. 2J presents a diagram showing a login center of influence web form which gathers information including demographic and financial information for centers of influence in an embodiment disclosed herein. Each CPA, Referral Business Owner (RB Owner), and Referral Business Member (RB Member) will be provided with a link to the COI web form. Other subsequent web forms will gather information (such as bank account or credit card) in order to pay commissions.

FIG. 3A presents an alternative embodiment having an alternative step 201 of FIG. 2A in a view of 5-Step to Join Flow Module Diagram for sending the 5-Step Link to CPA's disclosed in a System and Method of Accounting/Tax Preparation Referrals in an embodiment disclosed herein. The process begins at step 300 when step 201 of FIG. 2A is reached, whereupon CPAs are sent 301 a 5-Step link to LinkedIn™ user contacts inviting them to join SASBA. This link (www.sasba.org/5-step-referral-join) is sent by InfusionSoft™ software or by control software 106 using referral translation software 107 for this purpose to various social media contacts on a given social media platform where it is received by them in step 302. The first of a predetermined number of messages (in this example seven messages) are sent to social media contacts in step 303 and then an administrative user compiles 304 information form InfusionSoft Analytics or using control software 106 to further refine marketing efforts. This is provided periodically by transmitting an email of the current state of the marketing effort to an administrator and then the process returns to FIG. 2A 202.

FIG. 3B presents a view of the analytic information provided by InfusionSoft. This information is used to further refine the marketing efforts to sign up CPAs as a SASBA CPA.

FIG. 4A presents a process of becoming a SASBA CPA in an alternative embodiment disclosed herein; FIG. 4A represents an alternative embodiment of the activity of steps 205-207 in FIG. 2A. In the decision box 202 of FIG. 2A control software 106 communicates with account management software 111 the current state of the membership. In this case, the applicant has decided to sign up to become a SASBA CPA so that in step 400 of FIG. 4A he or she is prompted by the account management software 111 to complete a sign up form which information is received by account management software 111 and accepts the terms and conditions of SASBA. An example of the SASBA terms and conditions page is shown in FIG. 4C. In step 401, demographic information is added to the CRM system of InfusionSoft™ and the tailor made software tags the user as a SASBA CPA and stored by InfusionSoft or control software 106 in association with or solely account management software 111 in server 102. A page from the content management program is shown in FIG. 4D thereby providing users with other potential marketing opportunities; items such as Tasks, Scored and Recent Activity, Referral Partner Tracking, Follow Up Sequences, Campaigns, Orders, Web Profile and more are provided to assist in marketing efforts.

At this point, tailor made software within the account management software 111 or using InfusionSoft™ communicates the acceptance of the user as a SASBA CPA to the control software which in turn communicates with streaming video software 110 to transmit a link to, or popup screen providing 402: a) a welcoming video; and b) a browser based or downloadable manual; again these are provided either in a popup or in a link transmitted to a user in an email. Finally, InfusionSoft™ sends an email or browser page with links 403 to training videos to contacts tagged SASBA CPA. Alternatively, control software 106 sends streaming video software 110 a command to transmit popup training videos to contacts tagged SASBA CPA links from the account management software 111. The process returns to point ‘C’ in FIG. 2D.

FIG. 4B presents a view of the CPA sign up web form of Module Diagram disclosed in a System and Method of Accounting Referrals in an embodiment disclosed herein. The web form provides text boxes for First Name, Last Name, Email, Phone Number and can be modified to include such things a social media, associations, groups and more.

FIG. 4C presents a view of the Terms and Conditions Addendum which is part of the SASBA CPA agreement in an embodiment disclosed herein. Various items are described such as a discounted return, CPA fees of $250 that may include state returns and other forms added to the base cost of a return, commission levels 10% or to be determined, Bonuses regarding ADP agreement provides individuals with a bonus of 50% of annualized billing, one time bonus of 25% of payroll customer's annualized billings.

FIG. 4D presents a view of the InfusionSoft contact record screen in an embodiment disclosed herein. A page from the content management program is shown in FIG. 4D thereby providing users with other potential marketing opportunities; items such as Tasks, Scored and Recent Activity, Referral Partner Tracking, Follow Up Sequences, Campaigns, Orders, Web Profile and more are provided to assist in marketing efforts.

FIG. 4E presents a view of a portion of the SASBA CPA manual table of contents including various topics related to the perfect referral business in an embodiment disclosed herein. Topics include: Reasons Why Small Businesses Should be included in your Marketing; SASBA CPA Referral Marketing Strategy; SASBA Foundational Beliefs; Ultimate Marketing Strategy Overview; Selling Products vs. Selling Services; The Five Step Selling Process; The SASBA TakeCharge Solution; The Initial Meeting; Before you Get Started; Etiquette Rules to Remember; Types of Prospects and Getting Leads.

FIG. 5 presents a followup process in the signing up of SASBA CPAs in an embodiment disclosed herein; FIG. 5 represents the activity of step 203 between steps 202 and 204 in FIG. 2A. The process begins 500 after the control software 106 or InfusionSoft™ software determines that the user did not signup for SASBA as shown in step 202 FIG. 2A where a NO is indicated. Step 203 comprises the steps by the aforementioned software to followup with the user declining membership. Thus, the process of following up has the control software 106 or InfusionSoft™ software (or account management software 111 alone or in combination with 106) sending 501 an email. This process is repeated for a predetermined number of emails over specified time periods.

Before decision diamond 202 in FIG. 2A, the control software 106 has set a counter to the predetermined number of email attempts (in this example 7). In step 502, the counter is decremented by one so as to indicate that one followup email attempt has been made to have the CPA join up. A check 503 is made by control software 106 to see if the counter has reached zero. If the counter reaches zero then the process returns 504 to FIG. 2A step 204 and no more attempts are made to contact that particular CPA.

If the counter has not reached zero then the process returns to FIG. 2A 202 waiting a predetermined time period to see if the user will join. If the user has not responded in a set time period or has indicated that he or she does not wish to join then the process returns from FIG. 2A 202 and another email is sent 501. The process repeats with the counter be decremented 502, the count checked 503 and looping back to FIG. 2A 202 and so forth. If at any time the user has signed up to join SASBA then the control software 106 or InfusionSoft™ software is programmed to cease sending emails and the process does not return to FIG. 5; rather the control software 106 (alone or in combination with account software 111 or account software 111 alone) or InfusionSoft™ software managing the signup at step 202 to a positive transition to step 205. Otherwise the process ends at step 204 when the counter reaches zero.

In an alternative embodiment, InfusionSoft completes a similar counting process using what is called a campaign. The campaign would have a goal as in this example CPA signs up. InfusionSoft sends a first email and after a certain time beyond the transmission of this first email, another email is sent to the prospective SASBA CPA. Then after another certain time period another email is sent until all of the predetermined numbers are sent (in this example seven). If it was desirable to use another number of emails, say 8 or 20 then the InfusionSoft user would simply put another time period with another email, i.e., 8 or 20. After a CPA has signed up, or after the final email has been sent and after a predetermined time period set by a user has passed, the InfusionSoft software will discontinue the campaign.

FIG. 6A presents the creation, transmission and utility of the personalized tracking links PTL in an embodiment disclosed herein. FIG. 2D 222 ends with a point D referring the process flow to the top of FIG. 6A point D. At this point a personalized tracking link (PTL) is transmitted by a COI to one or more contacts 601 who receive it in an email message. Thus, a personalized tracking link (PTL) is a link set to drive the recipient to a landing page such as www.sasba.org/referral-business-join. The personalized tracking link is created (FIG. 2D 222) by InfusionSoft™ software or by control software 106 alone or in combination with referral links translation software 107 to generate this link or provide a predetermined link. The generation of this link is an internal process that typically uses the name of the individual or other suitable marker to identify the link as his or hers. This personalized tracking link (PTL) connects 602 individuals to SASBA's landing page by linking them to this landing page which explains how The Perfect Referral Business overcomes any objection to starting a business.

The process continues showing in audio, video, and or text how using the personal tracking link (PTL) overcomes objections 603 to time involvement, selling anything, a reasonable expectation of profit and any other common objection starting a business. Finally, the landing page shows how SASBA provides 604 a powerful postscript to the system in audio, video and or text that highlights how the SASBA personal tracking link can be sent with a catchphrase “My CPA showed me a way I could save money on my taxes. I thought you may want to take a look yourself.” (send your personal tracking link). The final statement (send your personal tracking link) provides an easy demonstration of the amount of work necessary to comply with the IRS code's ‘reasonable expectation of profit’ by working at simply inserting those links in emails and or contacts on various social media pages and so forth. At this point the process ends as an individual user is acting as someone who is generating new referral leads. If a user receiving the personalized tracking link signs up then the sender of the PTL receives credit using the PTL as a reference. It should be apparent that the process whilst it states END at step 605 what is meant is that now this shows how to get a PTL transmitted from a signed up user out to a potential new member thereby completing the explanation of the process. However, it is understood that the process continues in that if the potential new member signs up then he will want to refer others and so forth.

FIG. 6B presents a Personalized Tracking link to a SASBA landing page describing how the personalized tracking link PTL overcomes various objections to starting a business in that there is little work involved, no direct selling involved and no up-front costs. The page also shows how there is a reasonable expectation of profit matching IRS guidelines. In particular, the Personalized Tracking Link generated by the referral links translation software 107 or by InfusionSoft′ provides each user with a personalize tracking link to a landing page—such as: (https://sg228.isrefer.com/go/refer/jharrison).

SASBA recommends that each referral business partner send this personal tracking link at least five times a month by including this response in correspondence such as email, text, or social media; amongst the targets of the campaign are friends, acquaintances and business associates who might be interested in saving on taxes and their using the accounting techniques that follow the unique value proposition provided by the instant disclosure. The correspondence would typically have a catchphrase in the postscript or other convenient location such as: ‘P.S. My CPA recently told me about a way I could save a lot on my taxes, and I thought that you may want to take a look yourself. Go to: https://sg228.isrefer.com/go/refer/yourname.

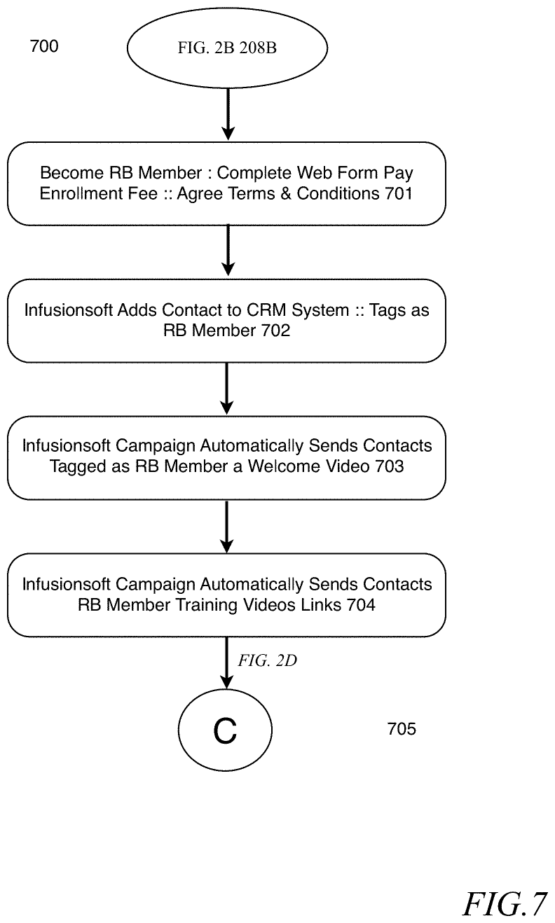

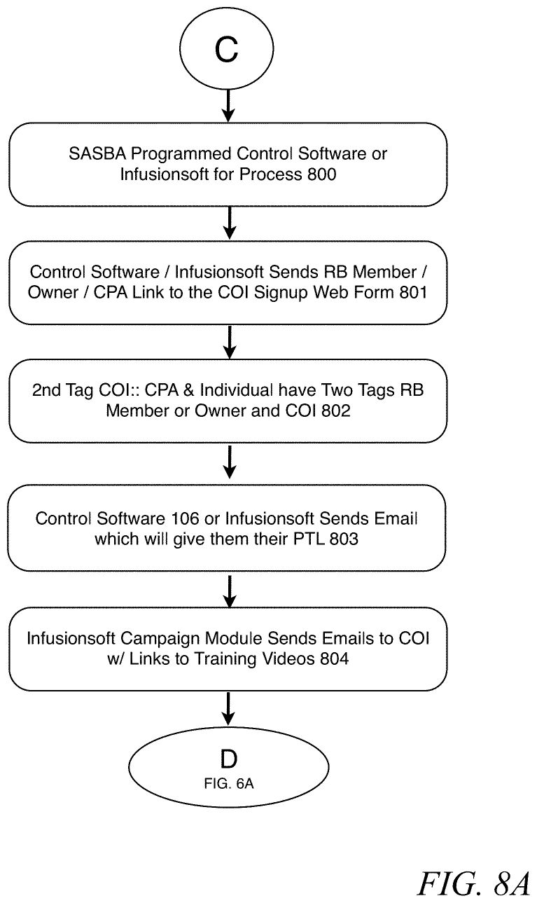

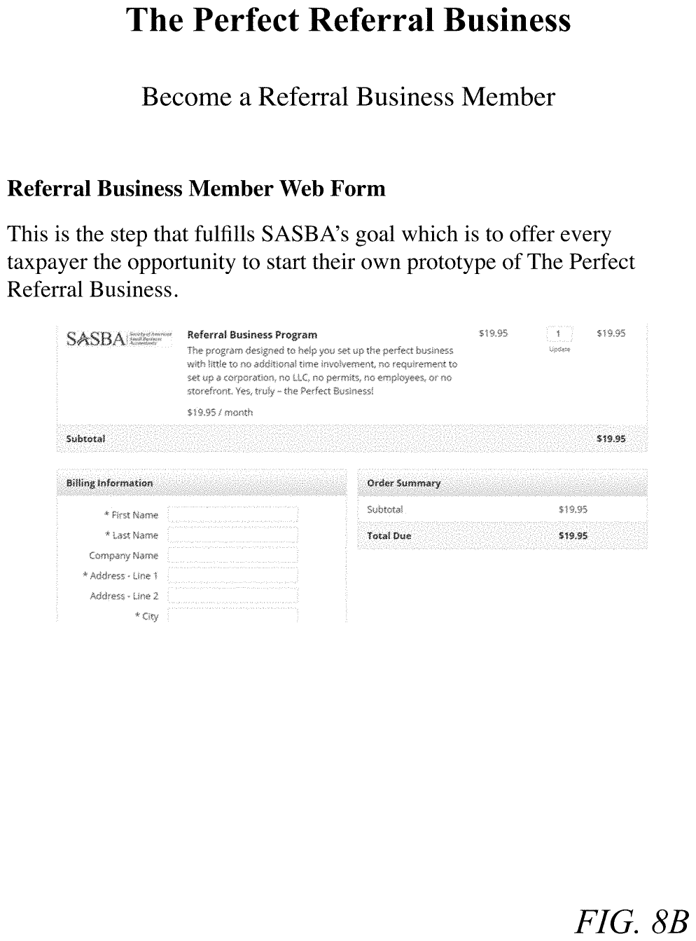

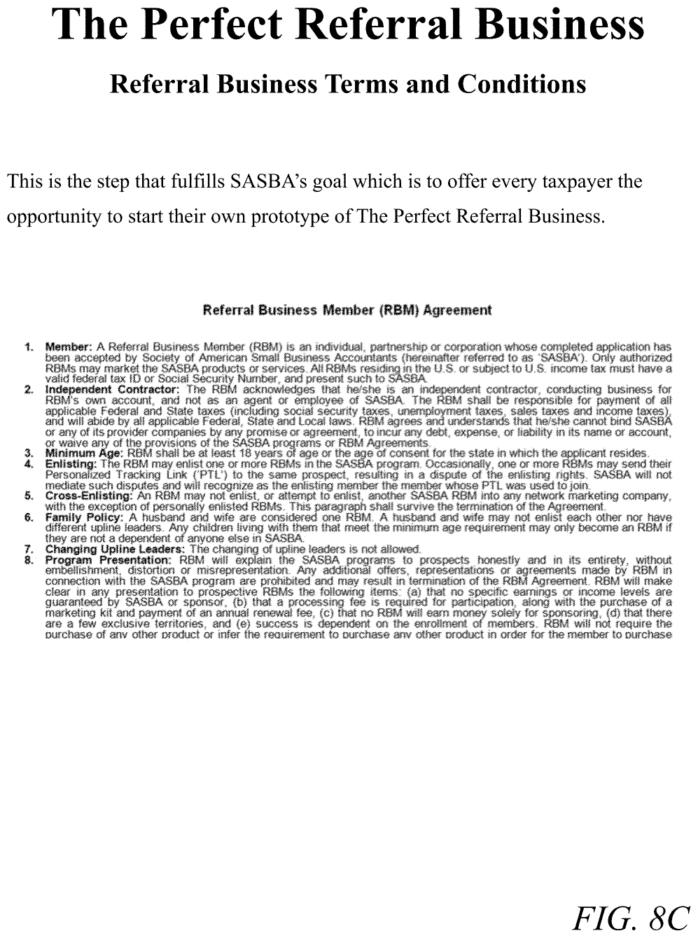

FIG. 7 presents an alternative process by which an individual referral business RB member having decided to join SASBA is accepted therein, is tagged as a RB Member and is sent corresponding initial information. The user having actuated a link to signup as a Referral Business RB Member or navigated to the SASBA site independently and attempted to join is presented by control software 106 with a sign up form and terms and conditions agreement. Thus, the process starts 700 from the positive response at FIG. 2B 208B and continues in step 701. In particular, step 701 of the process requires the signing of a web form with demographic information such as: first name, middle name, last name, company, address line 1, address line 2, city, state, zip code, country, phone number, email, alternative information box and so forth. This is more particularly shown with reference to FIG. 8B. A fee is also collected at this time and a payment screen is provided simultaneously or after entry of the demographic information and upon entry of appropriate payment information so that checkout can proceed.

It should appreciated that the control software 106 or InfusionSoft™ is also simultaneously providing a checkbox with a link or button to an independent terms and conditions page; alternatively, a form that must be viewed is presented to a user before or during checkout having a checkbox with scroll icon including the terms and conditions and is only accepted once the scroll icon translates down the page through user interaction; a typical terms and conditions for membership are shown more fully with respect to FIG. 8C.

Next, to ensure proper customer relationship management (CRM) InfusionSoft™ software or control software 106 using account management software 111 adds 702 this demographic information to a database and ensures that it is tagged with a Referral Business (RB) member tags; a personalized tracking link PTL is also added at this point and forwarded to a user through email from control software 106 alone or in association with link translation software 107 or link translation software 107 alone. A welcome video is sent 703 to the recently joined Referral Business (RB) member by the InfusionSoft™ software or control software 106 commanding video stream application software 110 to transmit a link in an email and or initiating a popup with a welcome video. Finally, the InfusionSoft™ software or control software 106 commands video stream application software 110 to transmit 704 a link in an email and or initiating a popup with training videos; these are sent periodically to the Referral Business (RB) member. At this point the process ends and the software returns to FIG. 2D point C 705 to join as a COI member item 220 in FIG. 2D.

FIG. 8A presents the software process by which a Referral Business Owner, a Referral Business Member or SASBA CPA having decided to join SASBA becomes a COI in an alternative embodiment disclosed herein. The process begins by points C of FIG. 2A-2C (FIG. 2A, 207; FIG. 2B, 211; FIG. 2C, 217) flowing from these various points ‘C’ to the point ‘C’ in FIG. 8A. At this point, the individual or SASBA CPA is directed to a referral partner module of InfusionSoft or control software 106 through the use of programmed software 800. At step 801, the InfusionSoft™ software or control software 106 transmits the aforementioned to the COI sign up web form. The information received from the web form is transmitted back to the appropriate software either InfusionSoft™ software or control software 106 or other software in modules above and stored in a database as appropriate.

Upon signup an individual or CPA would have two types of tags, these are namely, Referral Business (RB) Member or Owner and Center of Influence (COI); this latter tag is appended 802 to the existing information for the referral business using account software 111. The process step 803 has the InfusionSoft™ software or control software 106 in conjunction with referral links translation software 107 providing a personalized tracking link to the individuals and or SASBA CPAs through email link, popup form or similar modality. Next, a series of training videos 804 are provided periodically to Center of Influence persons with links to videos and the process continues with the transmission of benefits of SASBA page showing various additional features of the program as more fully shown with respect to FIG. 2E-2H. The process continues to point D in FIG. 6A.

FIG. 8B presents a web form whereby the user has actuated a link to signup as a Referral Business Member or navigated to the SASBA site independently; in so doing he or she is attempting to join and is presented by control software 106 or InfusionSoft′ with a sign up form in an embodiment herein disclosed. In particular, the signing of the web form requires demographic information such as: first name, middle name, last name, company, address line 1, address line 2, city, state, zip code, country, phone number, email, alternative information box and so forth. A fee is also collected at this time and a payment screen is provided simultaneously or after entry of the demographic information and upon entry of appropriate payment information so that checkout can proceed. This starts the process by which one can start a business with little to no additional time, no corporate requirement, no LLC, no permits, no storefront. Truly The Perfect Referral Business.

FIG. 8C presents a popup, linked page or page on the payment acceptance screen whereby various terms and conditions of the System and Method of Accounting/Tax Preparation Referrals in an embodiment herein disclosed. This web form is linked from the signup web form of FIG. 8B for example, or presented as a popup directly from a link thereon or as a popup before signup. It should be appreciated that the control software 106 or InfusionSoft′ is also simultaneously providing a checkbox with a link to an independent terms and conditions page; alternatively, a form that must be viewed is presented to a user before checkout having a checkbox with scroll icon including the terms and conditions is only accepted once the scroll icon translates down the page through user interaction.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD (digital versatile disc), CD (compact disc), memory stick, ROM (read only memory), RAM (random access memory), DRAM (dynamic random access memory), PROM (programmable ROM), EEPROM (extended erasable PROM), and/or other like computer-readable media.

In general, computer-readable memory media applied in association with embodiments of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C, Java, and/or a variety of other kinds of software programming languages that may be applied to create instructions in accordance with embodiments of the invention.

It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

The examples presented herein are intended to illustrate potential and specific implementations of the invention. It can be appreciated that the examples are intended primarily for purposes of illustration of the invention for those skilled in the art. For example, the configurations of screen displays depicted herein are provided by way of example. There may be variations to the diagrams, screen displays, or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

The above-described embodiments are merely exemplary illustrations of various implementations set forth for a clear understanding of the principles of the invention. Many variations, combinations, modifications or equivalents may be substituted for elements thereof without departing from the spirit and scope of the invention. Therefore, it is intended that the invention not be limited to the particular embodiments as disclosed, but that the invention will include all the embodiments falling within the scope of the appended claims.

1. A method of networked computer referrals comprising the steps of:
a computer server having control software loaded thereon transmitting an invitation across a computer network to an accountant using the control software for joining of a referral group;
receiving a positive reply from the accountant at the computer server;
the control software processing of the positive reply in the computer server and storing the positive reply within a referral space in of the computer server;
the computer server generating a signature to the positive reply using control software loaded into the computer server and storing the signature to the positive reply within a referral space associated with the positive reply previously stored therein.

2. The method of networked computer referrals of claim 1, wherein the signature further comprises a SASBA CPA tag.

3. The method of networked computer referrals of claim 1, further comprising the step of:
transmitting a web application form for an entry of demographic information and acceptance of terms.

4. The method of networked computer referrals of claim 1, further comprising the step of:
tagging a user of the method networked computer referrals as a unique type of entity using a tag referring to a type of membership of the referral group.

5. The method of networked computer referrals of claim 3, further comprises a tag from a group of tags of: a COI Member—center of influence tag, a RB Member—paying referral business individual tag, and a RB Owner—non paying referral business owner.

6. The method of networked computer referrals of claim 1, further comprising the step of:
the control software on the computer server transmitting a request to an individual without a business to join as a referral business member.

7. The method of networked computer referrals of claim 6, further comprising:
receiving an acceptance by an individual without a business at the computer server to join the referral plan.

8. The method of networked computer referrals of claim 7, further comprising the step of:
the computer server control software generating a tax satisfaction tag for the individual without a business.

9. The method of networked computer referrals of claim 8, wherein the tax satisfaction tag for the individual without a business further comprises: a referral business member tag.

10. The method of networked computer referrals of claim 8, further comprising the step of:
the control software storing the tax satisfaction tag for the individual without a business on the computer server in association with demographic information relating to the individual without a business.

11. The method of networked computer referrals of claim 1, further comprising the step of:
the control software on the computer server transmitting a request to an individual with a business to join as a referral business member.

12. The method of networked computer referrals of claim 11, further comprising:
receiving an acceptance by an individual with a business at the computer server to join the referral plan.

13. The method of networked computer referrals of claim 12, further comprising the step of:
the computer server control software generating a Referral Business owner tag for the individual with a business.

14. The method of networked computer referrals of claim 13, further comprising the step of:
the control software storing the Referral Business owner tag for the individual with a business on the computer server in association with demographic information relating to the referral business owner.

15. A method of networked computer referrals comprising the steps of:
a referral server in communicative association with a computer network transmitting a request to a potential associate across the computer network using control software stored on the referral server;
receiving an acceptance reply from the potential associate across the computer network at the referral server using the control software;
entering a referral signature datum into a referral signature table on the referral server using the control software on the referral server wherein the referral signature datum is from a set of referral signature data comprising: a CPA tag, a Referral Business Owner tag, A RB Member tag, IRS compliance tag.

16. The method of networked computer referrals of claim 15, wherein the referral signature datum further comprises a Center of Influence tag.

17. A networked computer system comprising:
a computer network having a networked computer server communicatively associated with the computer network such that the networked computer server has storage space therein;
wherein the storage space of the networked computer server has a software application space and a referral space; such that
the software application space has a software application module stored therein; and
wherein the referral space has a business activity referral datum stored therein thereby providing evidence to an Internal Revenue Service that an activity complies with Federal regulations for starting a business.

18. The networked computer system of claim 1, further comprising:
the referral datum is a Referral Business Member Signature.

19. The networked computer system of claim 1, further comprising:
a secondary referral datum.

20. The networked computer system of claim 19, wherein the secondary referral datum comprises a center of influence signature.
